(19) United States
(12) Patent Application Publication
(10) Pub. No.: US 2018/0284419 A1
(43) Pub. Date: Oct. 4, 2018

(54) METHOD FOR PRODUCING REFLECTION-CORRECTED IMAGES, MICROSCOPE AND REFLECTION CORRECTION METHOD FOR CORRECTING DIGITAL MICROSCOPIC IMAGES

(71) Applicant: CARL ZEISS MEDITEC AG, Jena (DE)

(72) Inventors: Martin PESCHKA, Aalen (DE); Norbert KERWIEN, Mogglingen (DE)

(21) Appl. No.: 15/941,664

(22) Filed: Mar. 30, 2018

(30) Foreign Application Priority Data
Apr. 4, 2017 (DE) 10 2017 107 178.4

(51) Int. Cl. G02B 21/36; G02B 21/06

(52) U.S. Cl. CPC G02B 21/367; G02B 21/06

(57) ABSTRACT

A microscope, a reflection correction method for correcting digital microscopic images and an apparatus for producing reflection-corrected, preferably microscopic, images of an object are provided. The apparatus comprises an illumination device with an illumination source and an illumination pupil for illuminating an object; an image recording sensor device that is configured to record a sequence of images of the object that belong to illumination situations, which differ from one another in each case; an image processing device that is configured to produce a reflection-corrected image from the sequence and a sub-aperture modulation device that is configured to produce the illumination situations, which differ from one another, in such a way that, for each image region in an image from the sequence containing a reflected illumination image of at least part of the illumination pupil, there is a corresponding image region without this reflected illumination image.

The present application claims priority to German Application No. 10 2017 107 178.4 filed Apr. 4, 2017, the disclosure of which is hereby incorporated by reference herein in its entirety.

### BACKGROUND OF THE INVENTION

### Field of the Invention

The present invention relates to an apparatus for producing reflection-corrected images, a microscope, and a reflection correction method for correcting microscopic images.

### Description of Related Art

Images of illuminated objects may contain reflections of the illumination on the object. By way of example, if use is made of ophthalmic operating microscopes, reflections of the illumination on the cornea, so called corneal reflections, may occur when observing the patient's eye.

In DE 196 38 263, a light absorber is introduced into the illumination beam path of an ophthalmic observation system in order to reduce this corneal reflection.

U.S. Pat. No. 7,570,408 shows that the corneal reflection can be reduced by way of the illumination with a controlled displacement between operating microscope and patient's eye.

Digital image processing facilitates the algorithmic, at least partial elimination of illumination reflections in recorded images. By way of example, if n images I₁, . . . , Iₙ of the same stationary object are recorded in n different illumination settings or illumination situations, wherein each illumination setting has m adjacent illumination settings, which are sorted in the set N(i), it is possible to calculate a reflection-corrected image I from

$$I = \frac{1}{n} {\sum }_{i = 1}^{n} {I}_{i} - \frac{1}{n} {\sum }_{j ∈ N ( i )} \frac{\vert {I}_{i} - {I}_{j} \vert}{m} .$$

By way of example, DE 10 2015 208 080 A1 describes a method in which various illumination situations are realized by means of a plurality of spatially distributed light sources (ring illumination made of a plurality of light-emitting diodes (LEDs)) in digital microscopes, wherein, to this end, the light sources are switched on and off in a time sequence, either individually or in groups. Then, images of the object are recorded for each of these illumination situations or illumination settings. The recorded images with the reflections of the light sources are combined with one another in a suitable manner by calculation in order to generate an image with reduced reflections of the light sources or largely without reflections of the light sources.

However, this requires a plurality of light sources that are arranged with clear separation from one another in space in order to be able to generate different illumination situations with illumination from different angles. This may be difficult to realize in some applications, for example when operating an ophthalmic operating microscope.

### SUMMARY OF THE INVENTION

By way of example, different illumination modes can be used in ophthalmic operating microscopes in order to be able to use suitable contrast methods for the respective operating phases on the eye. By way of example, use is made of the “red reflex illumination”, in which the ocular fundus is irradiated in a defined manner, said ocular fundus acting as a secondary light source and illuminating the lens and the cornea of the eye from the back and thus, in particular, facilitating an observation of scattering objects and phase objects (e.g. remains of the comminuted eye lens during a cataract operation). To this end, use can be made, in particular, of a coaxial illumination of the ocular fundus through the two observation channels of a stereoscopic operating microscope. If use is additionally made of an integrated assistant's microscope, this may increase the number of illumination channels for the coaxial illumination to 4, depending on the architecture of the operating microscope. If there additionally is an ambient illumination for the operating field, an even further illumination channel is obtained.

Each of these illumination channels leads to a corneal reflection, i.e. a reflected image of the illumination pupil of the illumination on the cornea on the operated eye in the observer image. By virtue of, firstly, the eye lying close to the object plane of the operating microscope, furthermore the radius of curvature of the cornea (e.g. in the region around approximately 7 mm) being very much smaller than the focal length of the objective in the operating microscope (e.g. in the region around 200 mm) and, moreover, the conjugate planes of the various illumination pupils having distances from the cornea that are substantially greater than the radius of curvature of the cornea (e.g. coaxial illumination ideally at infinity and ambient illumination typically in the vicinity of the principal objective, i.e., for example, 200 mm>>7 mm), the reflection of the illumination pupil light on the cornea causes the image location of this corneal reflection to come to rest very close to the image location of the observed object field. Therefore, such corneal reflections may be overlaid in the image region of interest in a bothersome manner.

It is an object of the present invention to facilitate the production of images, in particular microscopic images, of an object, in which reflections of illumination at the object are at least reduced, independently of the number of illumination sources and the angle between the illumination beam paths thereof and the observation beam path or paths.

According to the invention, this object is achieved by an apparatus for producing reflection-corrected images according to independent claim 1, and a microscope according to coordinate claim 11 and a reflection correction method for correcting digital microscopic images according to independent claim 17. Preferred configurations and developments of the invention emerge from the dependent claims.

The apparatus according to the invention for producing reflection-corrected images, preferably reflection-corrected microscopic images, of an object comprises an illumination device having an illumination source and an illumination pupil for illuminating an object. The apparatus moreover comprises an image recording sensor device that is configured to record a sequence of images of the object that belong to illumination situations, which differ from one another in each case, and an image processing device that is configured to produce a reflection-corrected image from the sequence. Moreover, the apparatus comprises a sub-aperture modulation device that is configured to produce the illumination situations, which differ from one another, in such a way that, for each image region in an image from the sequence containing a reflected illumination image of at least part of the illumination pupil, in particular an illumination image whose image location is situated at or near that of the object, there is a corresponding image region without this reflected illumination image in at least one of the remaining images from the sequence, wherein the sub-aperture modulation device comprises means for producing the illumination situations, which differ from one another, by a sequential modification of an illumination beam path from the illumination pupil to the object, wherein, in each case, i.e. for each of the illumination situations, which differ from one another, light from a respectively associated first sub-aperture region of the illumination pupil is incident on the object, while no light is incident on the object from a respective second sub-aperture region of the illumination pupil.

An illumination device comprises an illumination source or a light source and an associated illumination pupil. The illumination source can be a primary or a secondary illumination source. By way of example, a primary illumination source can be a halogen incandescent lamp, a gas discharge lamp or a light-emitting diode (LED). It can be a white light source or else a laser light source. In the case of a white light source, provision may also be made, for example, for influencing the illumination by virtue of introducing a filter into the illumination beam path, said filter only passing a selected spectral range. By way of example, the output of a mixer rod, of an optical waveguide, for example of an optical fiber, or of an optical waveguide bundle or of any other device that receives, and re-emits, light from a primary light source can be used as a secondary illumination source.

An illumination pupil is a real or virtual opening which delimits a light beam bundle emerging from the illumination device. If the light beam bundle enters into an optical system consisting of lenses or mirrors, for example, e.g. of a microscope, it may correspond to the opening of an aperture stop. The illumination pupil can also denote the image of the aperture stop in a conjugate plane after passing through the optical system. An optical system between the illumination source and illumination pupil may itself be part of the illumination apparatus, i.e. the illumination device with the illumination pupil optionally does not only comprise the illumination pupil at the illumination source itself but also the necessary optical system which steers the beam path from the illumination source into a plane that is conjugate to the illumination source, the beam path once again forming the illumination pupil in said plane.

Here, aperture denotes the cross-sectional area of the illumination pupil. A sub-aperture region of the illumination pupil denotes a component or a portion of the cross-sectional area of the illumination pupil which is smaller than the aperture, the latter consequently comprising at least two mutually disjoint sub-aperture regions. The respective first sub-aperture region and second sub-aperture region, which is disjoint from, i.e. non-overlapping with, the former, may together cover the entire region of the cross-sectional area of the illumination pupil. If this is not the case, the reflection correction can obtain at least a sub-optimal improvement.

The term sub-aperture region denotes a component of the cross-sectional area of the illumination pupil. The sub-aperture region can respectively be a contiguous region, but it may also consist of a plurality of non-contiguous portions that, together, form the respective first or the respective second sub-aperture region in another embodiment.

Here, the term object either denotes a complete object or at least part of same, from which light, which originates from the illumination, is recorded in an object-dependently modified form by way of the image recording sensor device and, when recording microscopic images, corresponds to the observed object plane or the observed object field or a part thereof. Here, light, which originates from the illumination, in an object-dependently modified form denotes, in particular, light reflected at the object or the surface thereof. By way of example, if the object is an eye or a part thereof, this, however, also includes, inter alia, light that was scattered back from the ocular fundus, said light transmitting the regions of the eye that are imaged in focus by a microscope (red-reflection illumination).

An image recording sensor device facilitates recording and optionally at least temporarily storing one or more images and it may comprise an apparatus for recording two-dimensional images from light by means of electricity. By means of the image recording sensor device, it is possible to record an electronic image and, in particular, a digital image of the observed object. By way of example, the image recording sensor device comprises a matrix of optoelectronic transducers, for example photodiodes, which convert the received reflected light signals into corresponding electrical or electronic signals that allow an automated evaluation. By way of example, semiconductor-based image sensors, for example CCD (charge-coupled device) sensors or active pixel sensors such as CMOS (complementary metal-oxide-semiconductor) sensors, can be used as an image recording sensor device. By way of example, a hyperspectral sensor also can find use as an image sensor, said hyperspectral sensor having not only three spectral channels (e.g. red, green and blue) but also a multiplicity of spectral channels.

By way of example, an image recording sensor device may comprise a digital camera.

The image recording sensor device is connected to an image processing device when recording digital images, for example by way of a data interface. By way of example, the image recording sensor device comprises a processor or microcontroller which is configured by way of a program to produce or calculate at least one image from the sequence of recorded images, the reflections of the illumination on the imaged object being not visible, or only visible to a reduced extent, in said at least one image. In one embodiment, the image processing device and the image recording sensor device are provided as a combined device. Moreover, the image processing device has a further interface for transferring the reflection-reduced image to a display device or image output device or a memory, which, for example, may be part of, or may be connected to, the apparatus for producing reflection-corrected images.

If the display device is part of a microscope, for example of an operating microscope, provision is made in one embodiment for the modification of the illumination situations and the recording and processing of associated images by the image recording sensor device or image processing device to be carried out at a frequency so that the observer has displayed to them the reflection-corrected image in the image output device or display device without perceivable delay. By way of example, this can be superimposed into the observation beam path of the operating microscope.

The image recording sensor device records a sequence of images that belong to illumination situations, which differ from one another in each case. The sequence consists of images recorded successively in time, wherein illumination situations, which differ from one another, are produced during this time period in order to illuminate the object differently, and (at least) one associated image of the object is recorded in each illumination situation.

In order to produce the different illumination situations, the apparatus according to the invention comprises a sub-aperture modulation device in order to modulate the illumination beam path, i.e. the beam path of an illumination pencil of rays from the illumination pupil to the object, such that a respectively associated first sub-aperture region of the illumination pupil emits light in each illumination situation while a respective second sub-aperture region of the illumination pupil does not emit light or at least emits light to an extent that is reduced in relation to the first sub-aperture region. Each illumination situation has a first and a second sub-aperture region of the illumination pupil which produce this illumination situation, i.e. a sequence of images is also assigned a sequence of different illumination situations and sequences of first and second sub-aperture regions.

An image region, corresponding to a (first) image region in an image from the sequence of images, in one of the remaining images of the sequence is an image region arranged spatially at the same position in the second image, said image region showing the content shown in the first image region in a different illumination situation. A sequence consists of at least two members; the sequence of images that belong to illumination situations which differ from one another consists of at least two images of the object that are recorded successively in time.

Unlike during the use of a simple, e.g. round or oval, stop with an adjustable diameter of a single opening, each image region that contains a reflected image of at least part of the illumination pupil, in particular an image whose image position is situated at or near to that of the object, has, for the purposes of facilitating a complete reflection correction or compensation, in one image, preferably each image, of the plurality of associated images a corresponding image region in one of the remaining images of the sequence in which the corresponding image region is not modified by the illumination reflection.

In order to sequentially modify the illumination beam path from the illumination pupil to the object, the sub-aperture modulation device is designed to influence the illumination pencil of rays, which emerges from the illumination pupil of the illumination device, in such a way that only the first sub-aperture region can emit light onto the object in each case. To this end, it is possible to modify the illumination beam path directly at the illumination pupil. In another embodiment, it is also possible to influence the illumination source itself in such a way that, depending on the illumination situation, only the respective first sub-aperture region at the illumination pupil emits light while the second does not.

By virtue of each image region in an image from the sequence that contains a reflected illumination image of at least part of the illumination pupil, in particular an illumination image whose image position is situated at or near that of the object, having a corresponding image region without this reflected illumination image in at least one of the remaining images of the sequence, a composition of the reflection-free image regions of the recorded image sequence covering the entire image region is ensured.

The use of an apparatus according to the invention for producing reflection-corrected images renders it possible to produce different illumination situations, independently of the number of illumination sources and the angle between the illumination beam paths thereof and the observation beam path or paths. The illumination reflection of a single illumination source can also be corrected or compensated. Instead of requiring a plurality of illumination sources, there now moreover is the option of correcting all or any combination of illumination reflections, or else of correcting individual illumination reflections in a selective manner, if a plurality of illumination sources are present. Here, it is not necessary to displace the observed object, the illumination device or the image recording sensor device relative to one another in terms of their spatial position. Moreover, it is not necessary for the illumination beam path to run along a substantially different angle in relation to the object or the object field than the observation beam path, as a result of which the apparatus is also suitable, in particular, for ophthalmic observation appliances and operating microscopes which, for example, use a coaxial illumination of the object field.

In one embodiment, the means for producing the illumination situations, which differ from one another, comprise means for respectively modifying the illumination beam path in such a way that, when considered over all the illumination situations, which differ from one another, the respectively associated first sub-aperture regions are disjoint from one another. If an overlap of the illuminating first sub-aperture regions is avoided, the calculations to be carried out by the image processing device are minimized. Particularly if, for example for reasons of speed, only two different illumination situations are produced, it is necessary for the respective first sub-aperture regions not to overlap in order thus to ensure that, in at least one of the illumination situations, each illuminating sub-aperture portion does not contribute to the illumination and consequently it also does not contribute to a possibly occurring illumination reflection at the surface of the object.

In a further embodiment of the apparatus for producing reflection-corrected images, the means for producing the illumination situations, which differ from one another, comprise means for respectively modifying the illumination beam path in such a way that, when considered over all the different illumination situations, a composition of the respective second sub-aperture regions covers the entire illumination pupil. This ensures that each component of the illumination pencil of rays which has an illumination reflection, regardless of the sub-aperture portion causing said illumination reflection, does not contribute to the occurrence of the illumination reflection by the associated illumination source in at least one of the recorded images of the sequence such that a complete compensation of the illumination reflection is facilitated, independently of the actual position of the illumination reflection in the recorded images.

In one embodiment of the apparatus according to the invention, the illumination pupil is a first illumination pupil at the illumination source and the sub-aperture modulation device is configured to modify the illumination beam path from the first illumination pupil. Here, the sub-aperture modulation occurs in the vicinity of the illumination source and can be effectuated, for example, by modulation of the illumination source itself. Moreover, an optical system, into which the beam path of the illumination subsequently enters where applicable, can be provided separately from the apparatus or at least separately from the sub-aperture modulation device such that the optical system may be part of an available microscope, for example, whereas the sub-aperture modulation device may be part of an upgradable module with which the functionality of the microscope can be expanded.

In another embodiment of the apparatus according to the invention, the illumination pupil is a second illumination pupil in a plane that is conjugate to the illumination source or in a plane downstream of said conjugate plane, and the sub-aperture modulation device is configured to modify the illumination beam path from the second illumination pupil. In this embodiment, the sub-aperture modulation can be integrated into a microscope, for example, but the sub-aperture modulation device can also be introduced into the illumination beam path between a main objective of the microscope and the object field to be observed, depending on the design of the illumination beam path. Thus, on the one hand, it is possible to avoid the proximity to the illumination source which, depending on the embodiment, may cause elevated temperatures in the surroundings thereof and may, under certain circumstances, only leave little space from a constructional point of view for the installation of a sub-aperture modulation device. On the other hand, if the sub-aperture modulation device can be introduced into the beam path as a module below the main objective, it is possible, if a driven sub-aperture modulator is used, to avoid the transfer of vibrations, for example produced by the latter, onto the optical system of the microscope and thus avoid influencing the observation of the object.

In one embodiment, the means for producing the illumination situations, which differ from one another, comprise means for intermittently shadowing the respective second sub-aperture region. Here, the respective second sub-aperture region is influenced intermittently or in a time varying manner during the associated illumination situation in such a way that no component of the illumination pencil of rays is incident on the object therefrom. To this end, the sub-aperture modulation device comprises a sub-aperture stop which, in a time varying manner in relation to the time belonging to the illumination situation, shadows the respectively associated second sub-aperture region. Here, the term “shadowing” denotes the masking of the component of the illumination pencil of rays belonging to the second sub-aperture region by way of a light-opaque sub-aperture stop which, at the time of shadowing, respectively has the form of the respectively associated second sub-aperture region. This facilitates the sub-aperture modulation by the use of, for example, a suitable, controllable sub-aperture stop which, if need be, may also be installed at a later time and which does not place any additional demands on the properties of the illumination source to be used or of the optical systems to be used.

As a rule, the light-opaque property of the sub-aperture stop is complete. However, in a specific embodiment, provision can also be made for the light intensity to only be substantially reduced without the light from the respective second sub-aperture region being completely masked. This renders it possible to still be able to visually localize the illumination reflections even in the reflection-corrected image, for example for the purposes of testing or aligning the illumination device or the object to be observed.

By way of example the means for intermittently shadowing the respective second sub-aperture region comprise a movable mechanical sub-aperture mask. By way of example, this can be an aperture stop that is horizontally and/or vertically movable in relation to the cross-sectional area of the illumination pupil by way of a drive apparatus or that is axially rotatable in respect of the illumination beam path.

In a further exemplary embodiment, the means for intermittently shadowing the respective second sub-aperture region or shadowing the latter in a time varying manner comprise an electronically actuatable aperture stop. Here, this may be an LCD (liquid crystal display) aperture stop or any other programmable stop, optionally combined with optical polarization elements, in which portions, for example individual elements or groups of elements of a matrix structure, are separately actuatable in an electronic manner and can be switched to be light-transmissive or shadowing. This offers the advantage of being able to use a stationary sub-aperture stop without elements to be moved by mechanical means, said moving elements otherwise possibly producing vibrations that could influence the observation result. Moreover, very high switching frequencies are possible by way of electronically switchable sub-aperture stops. Furthermore, an electronically programmable form of the sub-aperture stop allows the use of a large variety of structures or patterns and a retrospective modification of the selected form in order to adapt the latter to, for example, reflection properties of the currently examined object or other changeable influences, for example the intermittent presence of further illumination beam paths or modified parameters, for example when replacing the image recording device (reaction times, resolution). Also, in the case of use for different microscope types, provision can be made of different sub-aperture stop forms that are adapted to the properties of the respective microscope in order to realize time varying light-guiding and non-light-guiding stop regions.

In one embodiment, the means for producing the illumination situations, which differ from one another, comprise means for intermittently coupling the respective first sub-aperture region into the illumination beam path without simultaneously coupling-in the respective second sub-aperture region. By way of example, controllable movable or tiltable mirrors are suitable to this end, which mirrors, depending on how they are positioned relative to part of the illumination pencil of rays, steer or do not steer their part of the illumination pencil of rays directly or indirectly via an interposed optical system onto the object to be observed. By way of example, this may also be realized using a micro-electromechanical system (MEMS), in particular with a spatial light modulator, for example a digital micromirror device (DMD). A DMD consists of micromirror actuators that are arranged in a matrix form. These are stationary, mirroring areas which, separately in each case, can be tilted about an angle from one position into a second position by the force action of electrostatic fields and which permit very many, for example several thousand, of these switching processes per second.

Here, in one embodiment, the means for intermittently coupling the respective first sub-aperture region into the illumination beam path are configured to displace a position of the reflected illumination image of the respective first sub-aperture region in a targeted manner by a time-varying angle deflection. In this way, it is possible to modify illumination situations by virtue of the position of the reflection component, which belongs to a respective time as a result of the first sub-aperture region in each case contributing to the illumination at said time, having to be displaced, even without having to be masked. This, too, can be realized by tiltable mirrors or electronically actuatable DMD mirrors, i.e. a DMD microsystem, for example.

In a further embodiment, the means may also comprise means for tilting the illumination source itself between at least two angle positions. In this way, it is likewise possible to produce time-varying disjoint partial illuminations of the illumination pupil and consequently a sub-aperture modulation of the illumination.

In an even further embodiment, these means may also comprise means for varying an emission angle of the illumination beam path upon emergence from the illumination source. By way of example, an opto-acoustic modulator, e.g. a Bragg cell, is suitable as a modulation unit.

In a further embodiment, the means for producing the different illumination situations comprise means for intermittently activating separately actuatable sub-aperture regions of the illumination source. Instead of modulating the illumination beam path after emergence from the illumination source, the sub-aperture modulation is produced here by direct modulation of the illumination source. By way of example, this can be a segmented illumination source. This avoids modifying the construction of the appliance, for example of the microscope, with which the apparatus according to the invention is used.

In an exemplary embodiment, the illumination device comprises, as an illumination source suitable to this end, an LED chip having an illuminated field array, the elements of which can be activated separately.

In a further exemplary embodiment, the illumination device as an illumination source comprises a secondary illumination source, into which light that was modulated by the sub-aperture modulation device is fed, said light being emitted by a primary illumination source.

By way of example, the illumination device can comprise at least one optical waveguide bundle and the secondary illumination source can be an output of the optical waveguide bundle; i.e., the secondary illumination source can be the output of an optical waveguide bundle, by means of which light is emitted, said light being fed into the optical waveguide by a primary illumination source at the other end, wherein the sub-aperture modulation is effectuated by virtue of, for example, a corresponding device in each case shadowing a desired sub-aperture region by virtue of the feed into the corresponding optical waveguide of the bundle being inhibited, for example by way of a mechanically movable or electronically actuatable sub-aperture stop device. The latter can be arranged directly between the primary illumination source and the optical waveguide bundle or, for example, it can also receive the light bundle to be modulated indirectly from the primary light source by way of a further optical waveguide bundle. Such an apparatus offers the advantage that the primary light source can be arranged away from the remaining apparatus, it therefore being possible, for example, to take account of the heat development thereof. Moreover, the use of optical waveguide bundles allows the secondary illumination source to be mounted at positions that would otherwise be difficult to access, for example on account of structural limitations. Moreover, the sub-aperture modulation device can likewise be spatially separated from the remaining apparatus, as result of which, for example, vibrations arising as a result of the operation thereof are no longer transmitted, or are only transmitted with difficulties, to the remaining apparatus.

In a further embodiment, the apparatus comprises a further illumination device with a further illumination pupil for illuminating the object. The sub-aperture modulation device can be used to correct the illumination reflection of the first illumination pupil, even in the presence of one or else more further illumination devices. Independently thereof, for the further illumination device(s), provision can also be made for these to be respectively modulated by a corresponding sub-aperture modulation device such that the illumination reflections thereof can likewise be corrected. Here, the sub-aperture modulation device may physically comprise a plurality of sub-aperture modulators, respectively one for each of the illumination beam paths. By way of example, these can be adapted to illumination devices that possibly have different constructions.

By way of example, if the apparatus is applied in an operating microscope, the reflections can be corrected or compensated in this way for coaxial illuminations of the two stereo channels (for example eyepieces for the two eyes or other suitable display media, e.g. electronic display media), possibly, additionally, for those of an assistant's system (thus, it is also possible to correct illumination reflections caused by a plurality of coaxial illuminations), too, and, moreover, for a possibly present oblique illumination as well, for example for ambient illumination, or for a zero-degree illumination.

In an exemplary embodiment, the apparatus is therefore further configured to produce the illumination situations, which differ from one another, in such a way that, for each further image region in the image from the sequence containing a further reflected illumination image of at least a part of the further illumination pupil, in particular a further reflected illumination image whose image position is situated at or in the vicinity of that of the object, too, a further corresponding image region without this further reflected illumination image is present in at least one of the remaining images from the sequence. Here, the sub-aperture modulation device comprises means for producing the illumination situations, which differ from one another, by a sequential modification of a further illumination beam path from the further illumination pupil to the object, too, wherein, in each case, light from a respectively associated first sub-aperture region of the further illumination pupil is also incident on the object, while no light is incident on the object from a respective second sub-aperture region of the further illumination pupil. Consequently, it is possible to correct a plurality of selected illumination reflections, for example all illumination reflections.

In order to increase the processing speed, provision can furthermore be made in one embodiment for the synchronization of the sub-aperture modulations also to be carried out by the sub-aperture modulators, so as to be able to correct or compensate all illumination reflections together instead of in succession, by means of a sub-aperture modulation device consisting of a plurality of sub-aperture modulators, for example if the illumination reflections lie close together on the cornea of the patient's eye, like, for example, in the case of illumination reflections of the illuminations of an ophthalmic operating microscope.

The subject matter of one coordinate claim relates to a microscope, preferably an operating microscope, ophthalmic observation appliance, ophthalmic operating microscope or any other ophthalmic optical appliance, which comprises an apparatus according to the invention. In this way, the advantages and peculiarities of the apparatus according to the invention for producing reflection-corrected images are also implemented within the scope of a microscope.

In one embodiment, the apparatus is the microscope, operating microscope, ophthalmic observation appliance, ophthalmic operating microscope or other ophthalmic optical appliance itself. The appliances specified above are subsumed by the term microscope below. In another embodiment, it may be possible to add the apparatus to the microscope as a whole or to add it, at least in part, to the microscope as a module, this relating at least to the sub-aperture modulation device, whereas other parts of the apparatus are already part of the microscope or connectable to the latter via further interfaces, for example the image recording sensor apparatus and the image processing device.

Particularly in the case of operating microscopes, reflections of the illumination in the object field of the microscope may represent dangerous disturbances in certain circumstances and use is made of different illuminations, such as e.g. an ambient illumination, an oblique illumination, but, in particular, also a zero-degrees illumination and a coaxial illumination.

In such oblique illumination, the beam path runs at a relatively large angle (6° or more) with respect to the optical axis of the objective of the microscope and can run completely outside the objective or through the edge region of the objective. In the case of the 0° illumination, the illumination beam path runs through the objective of the microscope, along the optical axis of the objective 5, in the direction of the object plane or the object field. In the case of the coaxial illumination, the beam path (or the partial beam paths for a binocular microscope) is coupled into the microscope parallel to the optical axis of the observation beam path (or to the optical axes of the partial observation beam paths for a binocular microscope), for example with the aid of a beam splitter, and so the illumination beam path in each case runs coaxially with respect to the observation beam path.

Although a coaxial illumination can be particularly helpful in the case of an eye operation, for example, the illumination reflections are particularly dangerous in this case at the same time since these, on the cornea in the case of an eye operation, possibly directly overlay the relevant region in the illuminated object field to be observed. Type and expected position of the illumination reflections are approximately known, which is why this can also be taken into account when selecting the sub-aperture stops or in accordance with the sub-aperture illumination patterns.

In a preferred embodiment of the microscope according to the invention, the illumination beam path from the illumination source comprises a beam path of a coaxial illumination. In the case of the coaxial illumination, the illumination beam path runs parallel, at least in portions, to the optical axis of an observation beam path of the microscope. What is particularly advantageous here is that, in the approach according to the invention, the angle between the illumination beam path and the observation beam path is not relevant for being able to generate the various illumination situations. The reflections of coaxial illumination can also be corrected or compensated. This is possible even without having to spatially move an optical system of the microscope relative to the object, for example the patient's eye. Here, it should be noted that, for example, a plurality of beam paths from a plurality of coaxial illuminations can also be present in microscope according to the invention and it is also possible to correct the illumination reflections caused by multiple coaxial illumination beam paths.

A microscope that was retrofitted with an apparatus according to the invention for producing reflection-corrected images also represents an embodiment of the microscope according to the invention. By way of example, provision is made in one embodiment of the microscope for the apparatus to comprise means to only steer the modified illumination beam path onto the object in a region between an objective or main objective of the microscope and the object. By way of example, the illumination beam path was modified, i.e. modulated, by partial shadowing. To this end, the sub-aperture modulation device is arranged e.g. in this region between a main objective of the microscope and the object and the modulated illumination beam path is steered onto the object by means of, for example, an associated deflection mirror or the reflection path of an optical splitter, which was introduced into the observation beam path of the microscope below the objective of the microscope, i.e. between objective and object plane. In particular, this offers the advantage of being able to provide a module to this end, said module, where necessary, also being able to be fitted to the microscope retrospectively.

Other embodiments of the microscope provide for the modified illumination beam path to already be deflected upstream of the objective or main objective of the microscope and be guided through the objective or guided past the objective or be deflected between elements of the objective such that the modified illumination beam path runs through a portion of the objective.

In a preferred embodiment, the microscope has a display device or image output device which comprises at least a digital eyepiece, an eyepiece with data superimposition, a monitor or smartglasses. If modifying the illumination situations and recording and processing of associated images is carried out by the image recording sensor device or image processing device at a frequency that the observer has displayed to them the reflection-corrected image in the image output device or display device without perceivable delay, it is advantageous to use e.g. one or more digital eyepieces, eyepieces with data superimposition, a monitor or smartglasses as reproduction appliance or display device such that the user of the microscope can observe the reflection-corrected image in real time during the use of the microscope instead of the image disturbed by illumination reflections. Alternatively, or additionally, provision can also be made in an embodiment for both the reflection-afflicted and the reflection-corrected image to be made available for the user.

A reflection correction method according to the invention for correcting digital microscopic images comprises at least illuminating an object through an illumination pupil of an illumination device, recording a sequence of images of the object that belong to illumination situations, which differ from one another in each case, by way of an image recording sensor device, and producing a reflection-corrected image from the sequence using an image processing device. In particular, the reflection correction method according to the invention also comprises producing the illumination situations, which differ from one another, using an illumination modulation device in such a way that, for each image region in an image from the sequence containing a reflected illumination image of at least part of the illumination pupil, in particular an illumination image whose image position is situated at or in the vicinity of that of the object, there is a corresponding image region without this reflected illumination image in at least one of the remaining images from the sequence, wherein producing the illumination situations, which differ from one another, comprises producing the illumination situations, which differ from one another, by a sequential modification of an illumination beam path from the illumination pupil to the object, wherein, in each case, light from a respectively associated first sub-aperture region of the illumination pupil is incident on the object, while no light is incident on the object from a respective second sub-aperture region of the illumination pupil. In this way, the advantages and peculiarities of the apparatus according to the invention for producing reflection-corrected images and of a microscope comprising such an apparatus are also implemented within the scope of a reflection correction method for correcting digital microscopic images.

Thus, the reflection correction method is a method which is suitable for real-time-capable digital reflection suppression in digital images, in which the image of the object and the reflection light of the illumination pupil or of illumination pupils, where applicable, are superposed in the image plane (sensor plane of the recording appliance). In particular, this relates to the case in which the reflection image of the illumination pupil(s) comes to rest in or near the image plane of the object. Here, the light from the illumination pupil or the illumination pupils or from a location that is close to this or these conjugate plane(s) is manipulated in a spatial and time varying manner in such a way that regions of the illumination pupil(s) corresponding to individual or multiple regions of the reflection light of the illumination pupil(s) themselves do not contribute to the illumination at given times, while the remaining regions of the illumination pupil(s) contribute to the illumination at these times and wherein a suitable image sequence I₁, . . . , Iₙ of the object is recorded in such a way that each image region is free from, or largely free from, reflection light from the illumination pupil(s) in at least one image of the sequence. Then, a reflection-corrected digital image I of the object can be calculated from such an image sequence by means of suitable combination-by-calculation methods.

In one embodiment of the reflection correction method, the production of a reflection-corrected image from the sequence with an image processing device comprises calculating the reflection-corrected image or the reflection-corrected result image I according to the following formula:

$$I = \frac{1}{n} {\sum }_{i = 1}^{n} {I}_{i} - \frac{1}{n} {\sum }_{j ∈ N ( i )} \frac{\vert {I}_{i} - {I}_{j} \vert}{m} , \qquad ( 1 )$$

where n denotes the number of different illumination situations, Iᵢ denotes an image recorded in the i-th illumination situation and m denotes a number of illumination situations adjacent to the i-th illumination situation, which are sorted in the set N(i).

In this way, it is possible to reduce or eliminate differences between the images, with the similarities between the images being maintained.

Other methods, too, can be used for reducing reflections, said other methods being based on comparative threshold value criteria, for example.

By way of example, a further embodiment of the reflection correction method provides for the production of a reflection-corrected image to comprise an image combination-by-calculation of the sequence according to the formula

$$I = \frac{1}{n} {\sum }_{i = 1}^{n} {w}_{i} \cdot {I}_{i} - \frac{1}{n} {\sum }_{j ∈ N ( i )} \frac{\vert {w}_{i} \cdot {I}_{i} - {w}_{j} \cdot {I}_{j} \vert}{m} \qquad ( 2 )$$

from n individual images I₁, . . . , Iₙ with weightings w₁, . . . , wₙ, where each individual image I; has m neighbors, which are ordered in the set N(i) and the weightings are determined by local brightness comparisons of reflection-free image regions.

A further exemplary embodiment of the reflection correction method provides for the production of a reflection-corrected image to comprise an image combination-by-calculation of the sequence according to the formula

$$I = \frac{1}{n} {\sum }_{i = 1}^{n} {w}_{i} \cdot {I}_{i} - \frac{1}{n} {\sum }_{j ∈ N ( i )} \frac{\vert {w}_{i} \cdot {I}_{i} - {w}_{j} \cdot {I}_{j} \vert}{m} \qquad ( 3 )$$

from n individual images I₁, . . . , Iₙ with weightings w₁, . . . , wₙ, where each individual image Iᵢ has m neighbors, which are ordered in the set N(i) and the weightings are determined by deep-learning algorithms.

A further exemplary embodiment of the reflection correction method provides for the production of a reflection-corrected image to comprise an image combination-by-calculation of a sequence according to the formula

$$I ( x , y ) = \frac{1}{n} {\sum }_{i = 1}^{n} {w}_{i} ( w , y ) \cdot {I}_{i} ( x , y ) - \frac{1}{n} {\sum }_{j ∈ N ( i )} \frac{\vert {w}_{i} ( x , y ) \cdot {I}_{i} ( x , y ) - {w}_{j} ( x , y ) \cdot {I}_{j} ( x , y ) \vert}{m} \qquad ( 4 )$$

for each image pixel (x,y) from n individual images I₁, . . . , Iₙ with image-pixel-dependent weightings w₁(x,y), wₙ(x,y), where each individual image Iᵢ has m neighbors, which are ordered in the set N(i) and the weightings are determined by deep-learning algorithms.

A further exemplary embodiment of the reflection correction method provides for the production of a reflection-corrected image to comprise an image combination-by-calculation, which, in a first stage, detects reflection regions in the individual images I₁, . . . , Iₙ and, in a second stage, combines the individual images I₁*, . . . , Iₙ* freed from the detected regions with one another by calculation in the HDR method.

By way of example, provision can be made in this embodiment for the detection of the reflection regions in the individual images to be based on deep-learning algorithms.

In particular, the reflection correction method for correcting digital microscopic images may provide, for example, for the step of producing a reflection-corrected image from the recorded sequence of images to comprise, in a segmentation step, carrying out a deep-learning-based reflection segmentation for each image from the sequence and eliminating image regions that are detected as afflicted by reflections from the respective image and, in a combination-by-calculation step, carrying out a combination based on an HDR method by calculation of the images of the sequence resulting from the segmentation step for reflection-corrected imaging (HDR: high dynamic range). A further exemplary embodiment of the reflection correction method provides for the production of a reflection-corrected image to comprise an image combination-by-calculation by way of comparative threshold value methods.

The invention will be explained in more detail below in conjunction with the following description of exemplary embodiments, with reference being made to the attached drawings. In the drawings:

### BRIEF DESCRIPTION OF THE DRAWINGS

FIG. 1 shows a schematic illustration of an apparatus for producing reflection-corrected images according to an embodiment of the invention;

FIG. 2 shows a schematic illustration of a first example for a decomposition of an illumination pupil into respective first and second sub-aperture regions for producing different illumination situations;

FIG. 3 shows a schematic illustration of a second example for a decomposition of an illumination pupil into respective first and second sub-aperture regions for producing different illumination situations;

FIG. 4 shows a schematic illustration of a third example for a decomposition of an illumination pupil into respective first and second sub-aperture regions for producing different illumination situations;

FIG. 5 shows a schematic illustration of a fourth example for a decomposition of an illumination pupil into respective first and second sub-aperture regions for producing different illumination situations;

FIG. 6 shows a schematic illustration of a fifth example for a decomposition of an illumination pupil into respective first and second sub-aperture regions for producing different illumination situations;

FIG. 7 shows a schematic illustration of a sixth example for a decomposition of an illumination pupil into respective first and second sub-aperture regions for producing different illumination situations;

FIG. 8 shows a schematic illustration of a seventh example for a decomposition of an illumination pupil into respective first and second sub-aperture regions for producing different illumination situations;

FIG. 9 shows a schematic illustration of an eighth example for a decomposition of an illumination pupil into respective first and second sub-aperture regions for producing different illumination situations;

FIG. 10 shows a schematic illustration of a ninth example for a decomposition of an illumination pupil into respective first and second sub-aperture regions for producing different illumination situations;

FIG. 11 shows a schematic illustration of a tenth example for a decomposition of an illumination pupil into respective first and second sub-aperture regions for producing different illumination situations;

FIG. 12 shows a schematic illustration of a first example of a microscope with an apparatus for producing reflection-corrected images according to an embodiment of the invention;

FIG. 13 shows a schematic illustration of a second example of a microscope with an apparatus for producing reflection-corrected images according to a further embodiment of the invention;

FIG. 14 shows a schematic illustration of a third example of a microscope with an apparatus for producing reflection-corrected images according to a further embodiment of the invention;

FIG. 15 shows a schematic illustration of a fourth example of a microscope with an apparatus for producing reflection-corrected images according to a further embodiment of the invention;

FIG. 16 shows a schematic illustration of a fifth example of a microscope with an apparatus for producing reflection-corrected images according to a further embodiment of the invention;

FIG. 17 shows a schematic illustration of a sixth example of a microscope with an apparatus for producing reflection-corrected images according to a further embodiment of the invention;

FIG. 18 shows a schematic illustration of a seventh example of a microscope with an apparatus for producing reflection-corrected images according to a further embodiment of the invention;

FIG. 19 shows a schematic illustration of an eighth example of a microscope with an apparatus for producing reflection-corrected images according to a further embodiment of the invention;

FIG. 20 shows a schematic illustration of examples for sub-aperture illumination options of an illuminated field array of LED chip;

FIG. 21 shows a schematic illustration of a ninth example of a microscope with an apparatus for producing reflection-corrected images according to a further embodiment of the invention;

FIG. 22 shows a schematic illustration of an example for a sub-aperture stop that is suitable for use in a microscope according to FIG. 21;

FIG. 23 shows a schematic illustration of an example for the arrangement of an illumination module for a microscope;

FIG. 24 shows a schematic illustration of a first example for an illumination device with a sub-aperture modulation device;

FIG. 25 shows a schematic illustration of a further example for a sub-aperture stop;

FIG. 26 shows a schematic illustration of an example for a rotatably mounted receptacle of a sub-aperture stop;

FIG. 27 shows a schematic illustration of an example for a sub-aperture stop that is integrated into a hollow shaft motor;

FIG. 28 shows a schematic illustration of an example for a sub-aperture modulation device;

FIG. 29 shows a schematic illustration of a further example for a sub-aperture modulation device;

FIG. 30 shows a schematic illustration of another further example for a sub-aperture modulation device;

FIG. 31 shows a schematic illustration of a second example for an illumination device with a sub-aperture modulation device;

FIG. 32 shows a schematic illustration of a third example for an illumination device with a sub-aperture modulation device;

FIG. 33 shows a schematic illustration of a fourth example for an illumination device with a sub-aperture modulation device;

FIG. 34 shows a schematic illustration of a tenth example of a microscope with an apparatus for producing reflection-corrected images according to a further embodiment of the invention;

FIG. 35 shows a schematic illustration of an eleventh example of a microscope with an apparatus for producing reflection-corrected images according to a further embodiment of the invention;

FIG. 36 shows a schematic illustration of a twelfth example of a microscope with an apparatus for producing reflection-corrected images according to a further embodiment of the invention;

FIG. 37 shows a schematic illustration of a thirteenth example of a microscope with an apparatus for producing reflection-corrected images according to a further embodiment of the invention;

FIG. 38 shows a schematic illustration of a fourteenth example of a microscope with an apparatus for producing reflection-corrected images according to a further embodiment of the invention; and

FIG. 39 shows a schematic illustration of an example for a reflection correction method for correcting digital microscopic images according to a further embodiment of the invention.

### DETAILED DESCRIPTION OF THE INVENTION

Identical or similar elements have been provided with identical reference signs in the figures, to the extent that this is expedient.

It is understood that other embodiments can be used and structural or logical modifications can be undertaken, without departing from the scope of protection of the present invention. It is understood that the features of the various described exemplary embodiments can be combined with one another, provided there is no specific statement to the contrary. Therefore, the description should not be considered restrictive and the scope of protection of the present invention is defined by the attached claims.

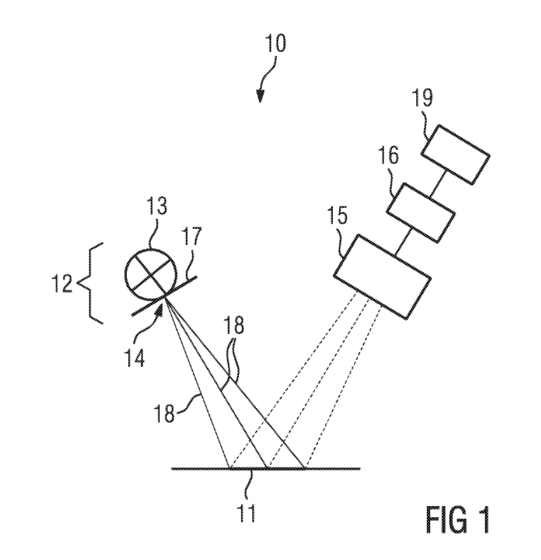

FIG. 1 shows a schematic illustration of an apparatus 10 for producing reflection-corrected images of an object 11 according to an embodiment of the invention. In FIG. 1, the object 11 is presented in a manner reduced to the observed object field. The apparatus 10 comprises an illumination device 12 with an illumination source 13 and an illumination pupil 14 for illuminating an object 11. Moreover, the apparatus 10 has an image recording sensor device 15, by means of which it is possible to record a sequence of images of the object 11 that belong to illumination situations, which differ from one another in each case. The image recording sensor device 15 is connected to an image processing device 16 (or forms a structural unit with the latter) that is configured to produce a reflection-corrected image from the sequence. To this end, the image processing device 16 may comprise a processor, a memory and programming, for example, by means of which a reflection correction method is carried out and a reflection-corrected image is synthesized from the sequence of images.

Moreover, the apparatus 10 comprises a sub-aperture modulation device 17 that is configured to produce the illumination situations, which differ from one another, in such a way that, for each image region in an image from the sequence containing a reflected illumination image of at least part of the illumination pupil 14, in particular an illumination image whose image location is situated at or near that of the object, there is a corresponding image region without this reflected illumination image in at least one of the remaining images from the sequence, wherein the sub-aperture modulation device 17 comprises means for producing the illumination situations, which differ from one another, by a sequential modification of an illumination beam path 18 from the illumination pupil 14 to the object 11, wherein, in each case, light from a respectively associated first sub-aperture region of the illumination pupil 14 is incident on the object 11, while no light is incident on the object 11 from a respective second sub-aperture region of the illumination pupil 14.

The image processing device 16 can have an interface in order to output reflection-corrected images, for example to a memory or, as shown in FIG. 1, to an image display device 19, which comprises a monitor, for example, in order to display the images.

In one embodiment, the image recording sensor device is configured to record the images with the same frequency with which the sub-aperture modulation device modifies the illumination situations. In a further embodiment, the image recording sensor device records images while the sub-aperture modulation device changes the illumination situations and the image processing device is configured to detect the change in the illumination situations in the recorded sequence and either to select images, which belong to the different illumination situations, for reflection correction purposes or to synchronize the image recording sensor device with the sub-aperture modulation device. To this end, provision can be made of a controller device (not shown), for example, by means of which the synchronous operation of producing the illumination situations, which differ from one another, with the sub-aperture modulation device and recording at least one image for each of these illumination situations is ensured.

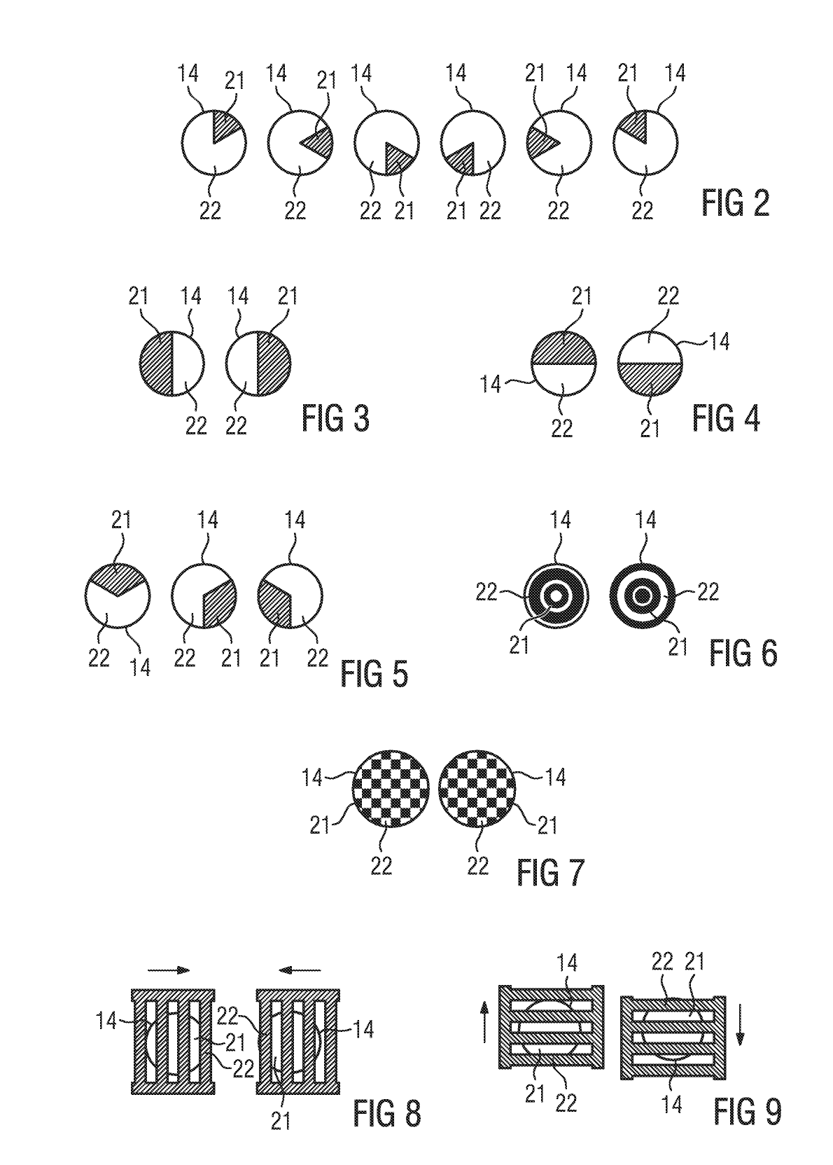

FIG. 2 shows a schematic illustration of a first example for a decomposition of an illumination pupil into respective first and second sub-aperture regions for producing different illumination situations, for example by way of the sub-aperture modulation device 17 in FIG. 1. The sub-aperture modulation device 17 shown in FIG. 1 decomposes the cross-sectional area of the illumination pupil 14 of the associated light source or illumination source 13 into n (n=6 in FIG. 2) spatially disjoint respective first sub-aperture regions 21 (illustrated by hatching here), through which light from the illumination source 13 can be incident on the object 11, and associated respective second sub-aperture regions 22 (illustrated in white here), though which no light can be incident on the object, in a temporally sequential manner. The union of the disjoint respective first sub-aperture region 21 over all n=6 illumination situations need not necessarily result in the overall region of the cross-sectional area of the illumination pupil 14 again. However, this is the case in the shown example. Light only emerges from the respective first sub-aperture region 21 in all 6 illumination situations. As a result of this procedure, different image regions will always be afflicted by reflections in the various images recorded by the image recording sensor device 15. The reflection of the entire illumination source is then largely eliminated by calculation by way of the image processing device 16, for example under the application of formula (1). Other methods, too, can be used for eliminating reflections, said other methods being based on comparative threshold value criteria, for example. In any case, the reflection-corrected image is synthesized from the reflection-free portions of the sequence of images.

The basic form of the illumination pupil 14 that is illustrated as circular in FIG. 2 is not mandatory. By way of example, elliptical, rectangular or polygonal illumination pupil forms are also possible. Furthermore, the basic form of the illumination pupil 14 need not consist of a contiguous region in all cases but can itself consist of spatially separated regions.

Further examples for decomposing an illumination pupil into respective first and second sub-aperture regions for producing different illumination situations are illustrated schematically in FIGS. 3-8. Further ones are conceivable, depending on contrasting method and combination of images.

FIG. 3 shows a second example, in which the sequence of different illumination situations consists of two illumination situations and the illumination pupil 14 is decomposed into respectively two disjoint first sub-aperture regions 21 and respectively two second sub-aperture regions 22.

FIG. 4 shows a third example, which differs from the second example only in the orientation of the sub-aperture regions. FIG. 5 shows a fourth example, in which three different illumination situations are produced, wherein the illumination pupil 14 is decomposed into respectively three disjoint first sub-aperture regions 21 and respectively three second sub-aperture regions 22.

FIG. 6 and FIG. 7 show a fifth and a sixth example, in which the illumination pupil 14 is decomposed into disjoint first (illustrated black in this case) and second (illustrated white) sub-aperture regions 21, 22, with the sub-aperture regions in these two examples respectively running through one another. These leads to very similar illumination conditions and, in the ideal case, the associated images differ for the two disjoint decompositions only by way of the likewise disjoint intensity distributions of the reflection images in the respective images and can be removed by calculation while avoiding the loss of other image information. Sub-aperture regions running through one another are particularly suitable for corneal reflection suppression in ophthalmic observation appliances or operating microscopes, i.e. for correcting the reflection of the illumination source on the cornea of the patient's eye.

For the purposes of suppressing corneal reflections while maintaining an otherwise unchanged image impression, it is advantageous if the disjoint regions lie close together or are realized by alternating decompositions of the illumination pupil that run through one another since particularly similar images then arise from the n illumination settings, which substantially only differ by the intensity distributions of the corneal reflections in the image, which ideally are disjoint again themselves. Since the elimination method according to formula (1) substantially removes the differences from the various images, this removes the loss of image information.

FIG. 8 and FIG. 9, too, show that the illumination pupil 14 is decomposed into disjoint first and second sub-aperture regions 21, 22 in a seventh and an eighth example, with the sub-aperture regions in these two examples respectively running through one another, wherein the respective first sub-aperture region 21 is illustrated in white and the respective second sub-aperture region is illustrated with hatching. The examples in FIG. 8 and FIG. 9 elucidate how the sub-aperture modulation can be realized by a moving stop.

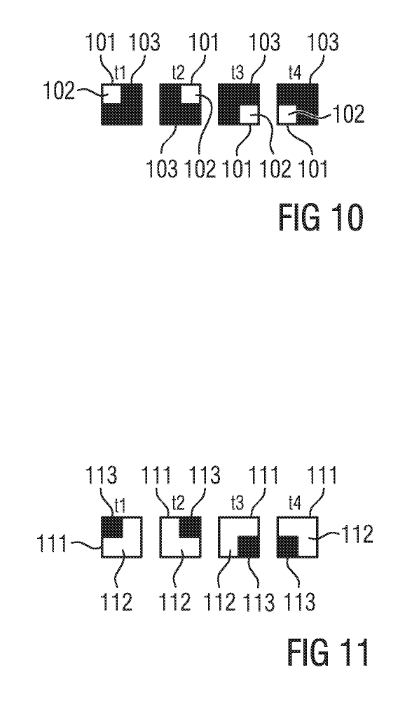

FIG. 10 shows a schematic illustration of a ninth example for a decomposition of an illumination pupil into respective first and second sub-aperture regions for producing different illumination situations. The decomposition of the illumination pupil 101, which is rectangular in the shown example, into disjoint first sub-aperture regions 102, which are illustrated in white, is only mandatory if the intention is to work with only two illumination settings for only two different illumination situations in order thus to facilitate the greatest possible speed during image recording and image processing. However, if more than two illumination settings are used (four in the case shown here), it is not generally mandatory. In the shown example, the respective first sub-aperture regions 102 are disjoint from one another, i.e. the regions of the illumination pupil 101 that are illustrated in white and shine at the times t1 to t4 do not overlap, whereas the respective second sub-aperture regions 103, which are illustrated in black, do overlap when considered over the times t1 to t4. By way of example, a rectangular illumination pupil 101 may be present if it corresponds to the illuminated field array of an LED chip as an illumination source.

It is also possible to use a division of the illuminated fields that is inverted thereto. FIG. 11 shows a schematic illustration of a tenth example for a decomposition of an illumination pupil into respective first and second sub-aperture regions for producing different illumination situations, in which four disjoint dark regions or second sub-aperture regions 113 (illustrated black in this case) of the illumination pupil 111 are provided, while the four shining first sub-aperture regions 112 (illustrated white in this case) respectively correspond, in pairs, on two quadrants of the illumination pupil 111, i.e. overlap. The shining regions of the illumination pupil 111 are imaged as reflections in the recorded images. The described reflection correction nevertheless works for as long as the composition of the reflection-free image regions, considered over the entire recorded sequence of images, covers the whole imaging region.

The apparatus according to the invention is preferably an apparatus for producing reflection-corrected microscopic images of the object. Therefore, embodiments of microscopes with such an apparatus are described in particular below, said microscopes differing in terms of the location and the means for the sub-aperture modulation. In particular, the shown exemplary embodiments can be digital ophthalmic operating microscopes with ambient illumination and coaxial illumination.

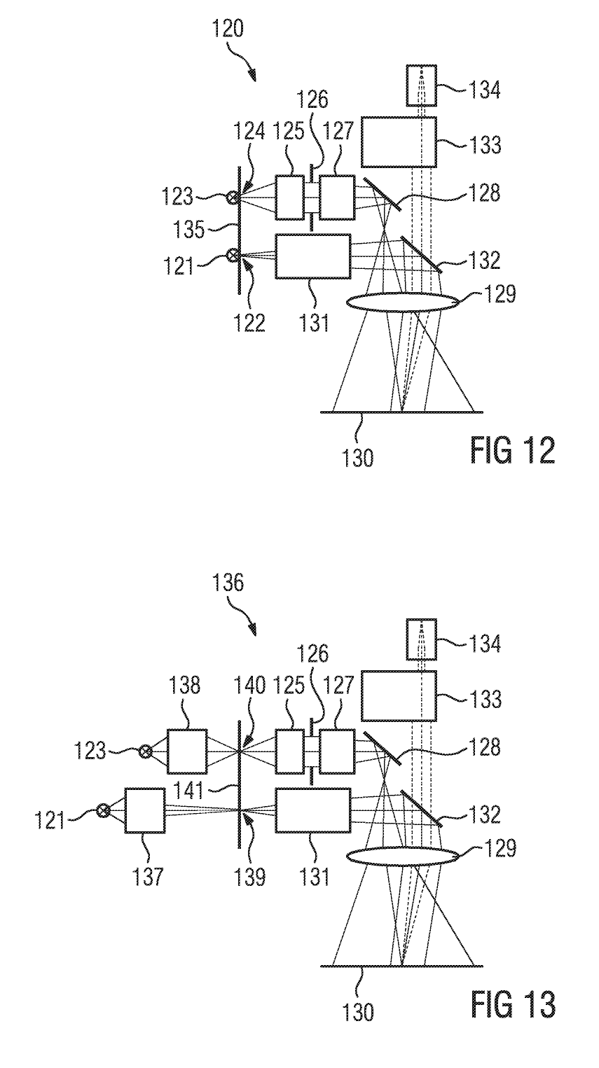

FIG. 12 shows a schematic illustration of a first example of a microscope 120 with an apparatus for producing reflection-corrected images according to an embodiment of the invention. The microscope 120 has a coaxial illumination (1 channel per observation channel). To this end, the microscope has a coaxial illumination source 121 with a coaxial illumination pupil 122. In FIG. 12, only one of usually two coaxial illuminations is illustrated in the side view for reasons of clarity. If the microscope additionally has a coaxial assistant's system, two further illuminations are present.

Moreover, the shown microscope 120 uses an ambient illumination. To this end, the microscope 120 has an ambient illumination source 123 with an ambient illumination pupil 124. Here, and in the embodiments described below, the ambient illumination is designed as a Köhler illumination, although this is not mandatory. What is essential is that the illumination pupil is accessible for the sub-aperture modulation by decomposing the illumination pupil. The ambient illumination device overall comprises the ambient illumination source 123, an optical system 125, a radiant field stop 126 and a further optical system 127. The ambient illumination beam path is imaged into the object plane 130 through the illuminated radiant field stop 126, via a deflection mirror 128 and through the main objective 129 of the operating microscope 120. The object plane 130 or the object field corresponds to the portion (of the surface) of an object observed through the microscope, i.e. the whole object or a portion of the object depending on the object.

By way of example, the main objective 129 can be embodied as an achromatic or apochromatic objective. The object field or the object plane 130 is arranged in the focal plane of the main objective 129, for example, and so it is imaged at infinity by the latter such that the observation beam path of a divergent beam bundle emanating from the object plane 130 is converted to that of a parallel beam bundle upon its passage through the main objective 129.

The shown coaxial illumination device (just like the coaxial illumination device not shown) comprises the coaxial illumination source 121 with the coaxial illumination pupil 122 and an optical system 131. Its associated coaxial illumination beam path is input coupled in the shown exemplary embodiment by the reflection path of an optical splitter 132 and steered into the object plane 130. The observation beam path (dashed lines), by means of which the image of the object is recorded, runs through the main objective 129, the transmission path of the optical splitter 132, and through (an optional/optional) magnification system/systems 133.

The coaxial illumination beam path is input coupled into the microscope by the reflection path of the beam splitter or optical splitter 132 in a fashion parallel to the optical axis of the observation beam path such that the illumination runs in coaxial fashion between the optical splitter 132 and main objective 129 in relation to the observation beam path. As a rule, if the microscope is a binocular operating microscope, a further illumination beam path and observation beam path is present. Then, for example, a further magnification system or the second channel in a stereo system may be provided for the further observation beam path. However, in the case of suitable dimensioning of the magnification system 133, the further observation beam path may also additionally run therethrough.

Reference is made to the fact that the illumination beam paths illustrated in FIG. 12 are very schematic and do not necessarily reproduce the actual course of the illumination beam paths.

For the purposes of recording an image of the object, a recording device with digital observation port(s) 134, one observation port per observation channel, is provided in FIG. 12. Two observation ports should be provided for two observation channels for a main observer. If the microscope 120 additionally comprises a coaxial illumination and optical systems for an assistant, two further observation ports should be provided.

A digital observation port 134 comprises an image recording sensor device for recording the images and an image processing device in order to synthesize at least one reflection-corrected image from the recorded images and it can comprise an image display device in order to display the reflection-corrected image. Instead of the digital observation port 134 comprising the image processing device, the former may also have, for example, a digital interface in order to connect a separate image processing device thereto, the recorded images being transferred via said interface to the image processing device so that the latter calculates the reflection-corrected image.

In the shown embodiment, the microscope 120 comprises a sub-aperture modulation device 135 in or near the plane of the illumination pupils. The sub-aperture modulation device decomposes the coaxial illumination pupil 122 and the ambient illumination pupil 124 in or in the direct vicinity of the plane of the illumination pupils, i.e. at or in the vicinity of the location of the illumination sources, into respective first light-transmitting and second shadowing sub-aperture regions. The illumination pupil decomposition is effectuated here by time-varying shadowing of the respective second sub-aperture regions in the plane of the illumination pupils. To this end, the sub-aperture modulation device 135 comprises movable mechanical stops. In a further embodiment, one or more actuatable LCD aperture stops, for example, are used instead of movable mechanical stops for targeted disjoint illumination pupil shadowing in order to produce the various illumination situations.

The reflection correction can be effectuated sequentially for all illumination channels. It is real-time capable. In the case of a sufficiently high image recording rate by the observation ports and sufficiently fast image combination-by-calculation, it is consequently possible to calculate reflection-freed or greatly reflection-reduced real-time images for the various illuminations of the observed object in the microscope and said images can be observed by the user, for example by way of the corresponding display device or the corresponding reproduction medium (monitors, digital eyepieces).

Further embodiments of a microscope according to the invention with an apparatus for producing reflection-corrected images are shown below, in which certain features differ from those of the embodiment shown in FIG. 12, while other features correspond. In order to avoid repetition, the description of the following exemplary embodiments is restricted to the features differing from those shown in FIG. 12, with the same reference signs referring to the same or similar components.

FIG. 13 shows a schematic illustration of a second example of a microscope with an apparatus for producing reflection-corrected images according to a further embodiment of the invention. The shown embodiment of a microscope 136 corresponds in substantial parts to the microscope 120 shown in FIG. 12. However, the microscope 136 additionally has an optical system 137 in the coaxial illumination beam path and an additional optical system 138 in the ambient illumination beam path, by means of which further illumination pupils 139, 140 arise as intermediate images of the original illumination pupils in the plane of the illumination pupils that is conjugate to the illumination sources 121, 123. In the shown embodiment, provision is made of a sub-aperture modulation device 141 in order to carry out the sub-aperture modulation at or in the direct vicinity of these illumination pupils 139, 140. Like in the embodiment described in FIG. 12, this can be effectuated by time-varying shadowing of the respective second sub-aperture regions of the respective illumination pupils, for example by moving mechanical stops or by one or more actuatable LCD aperture stops for targeted disjoint pupil shadowing for the individual illuminations.

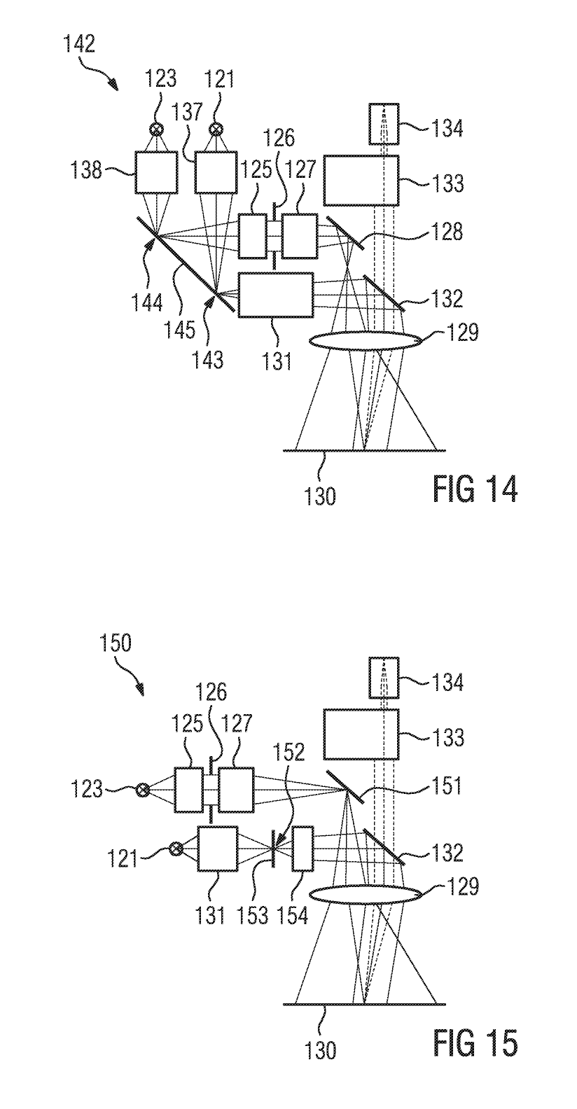

FIG. 14 shows a schematic illustration of a third example of a microscope with an apparatus for producing reflection-corrected images according to a further embodiment of the invention. The shown embodiment of a microscope 142 corresponds in substantial parts to the microscope 136 shown in FIG. 13. The microscope 142, too, comprises an additional optical system 137 in the coaxial illumination beam path and an additional optical system 138 in the ambient illumination beam path, by means of which illumination pupils 143, 144, which are in addition to the illumination sources 121, 123, arise as intermediate images of the original illumination pupils in planes conjugate thereto. In the shown embodiment, provision is made there of a sub-aperture modulation device 145 in order to carry out the sub-aperture modulation at these illumination pupils 143, 144. Here, the sub-aperture modulation device 145 comprises an electronically actuatable DMD (digital micromirror device) micro-system. Instead of shadowing selected sub-aperture regions, the respective illumination beam path is modified, i.e. the illumination pupil area is decomposed, here by the intermittent or time-varying input coupling of the respective first sub-aperture regions, i.e. of the regions of the illumination pupils that are provided for the sub-aperture illumination in the respective illumination situation. As shown, a commonly employed DMD or DMD micro-system 145 may be provided to this end for the disjoint, time-varying sub-aperture region input coupling for the individual illumination beam paths. In a further embodiment, a dedicated DMD is provided for individual illumination beam paths or for each illumination beam path.

FIG. 15 shows a schematic illustration of a fourth example of a microscope with an apparatus for producing reflection-corrected images according to a further embodiment of the invention. The illustrated embodiment of the microscope 150 shows that the options for the sub-aperture modulation shown in FIG. 13 and FIG. 14 are combinable with one another and that it is thus possible, for example, to provide an adaptation of the structure that is optimized for the respective illumination. While the sub-aperture modulation device 151 is provided as a DMD micro-system for the sub-aperture modulation of the ambient illumination beam path from the ambient illumination source 123 in order to facilitate a time-varying input coupling of sub-aperture regions of the ambient illumination pupil, an illumination pupil 152 is initially produced in a plane conjugate to the coaxial illumination source 121 in the coaxial illumination beam path from the coaxial illumination source 121 by means of the optical system 131, said illumination pupil then being modulated by a sub-aperture modulation device 153, for example by way of moving mechanical stops or one or more actuatable LCD aperture stops for targeted disjoint illumination pupil sub-aperture region shadowing. The coaxial illumination beam path modified thus is then steered via a further optical system 154, the optical splitter 132, and the main objective 129 onto the object plane 130.

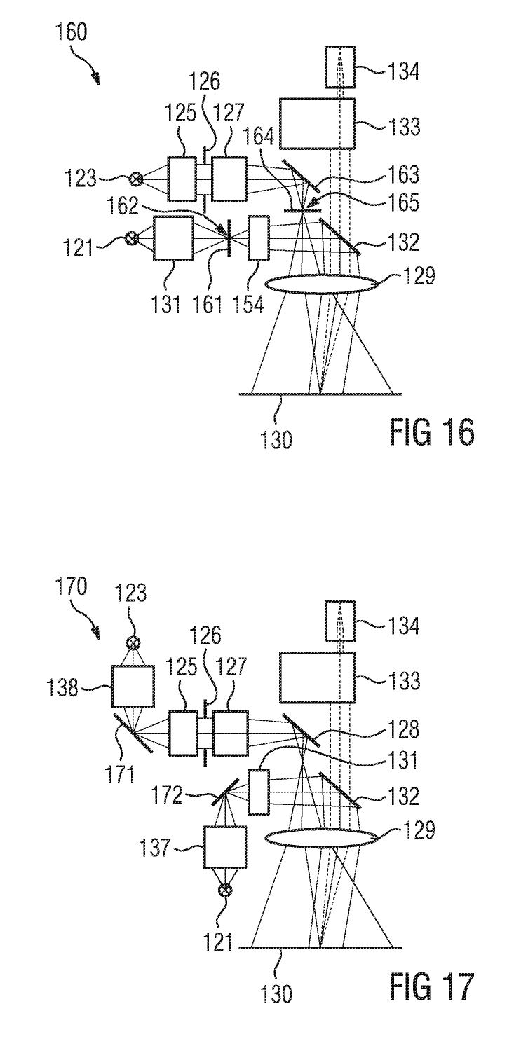

FIG. 16 shows a schematic illustration of a fifth example of a microscope with an apparatus for producing reflection-corrected images according to a further embodiment of the invention. The shown embodiment of a microscope 160 corresponds in substantial parts to the microscope 150 shown in FIG. 15. While the sub-aperture modulation for the coaxial illumination source 121 corresponds to that shown in FIG. 15 and the sub-aperture modulation is carried out by a sub-aperture modulation device 161 in a plane at an illumination pupil 162 of the coaxial illumination beam path, provision is made in the microscope 160 of FIG. 16 for the DMD from FIG. 15, used for the sub-aperture modulation device 151, to be replaced by a deflection mirror 163 and for the sub-aperture modulation to be carried out by the ambient illumination pupil sub-aperture modulation device 164 at or in the direct vicinity of a further illumination pupil 165 of the ambient illumination beam path. In both sub-aperture modulation devices 161, 164, it is possible, for example, to use mutually independent moving mechanical stops or actuatable LCD aperture stops for targeted disjoint illumination pupil region shadowing for the individual illumination beam paths.

FIG. 17 shows a schematic illustration of a sixth example of a microscope with an apparatus for producing reflection-corrected images according to a further embodiment of the invention. The shown embodiment of the microscope 170 corresponds in substantial parts to the microscope 142 shown in FIG. 14, wherein the DMD micro-system 145 from FIG. 14, which was used for plurality of illumination beam paths, was replaced by a first DMD micro-system 171, by means of which there is only a realization of the sub-aperture modulation by time-varying superimposition of disjoint sub-aperture regions of the illumination pupil of the ambient illumination 123, and by a second DMD micro-system 172, by means of which there is a realization of the sub-aperture modulation by time-varying superimposition of disjoint sub-aperture regions of the illumination pupil of the coaxial illumination 121. The imaging of the illumination sources 121, 123 from ambient and coaxial illuminations onto the two DMDs is effectuated by way of the additional optical systems 137 and 138.

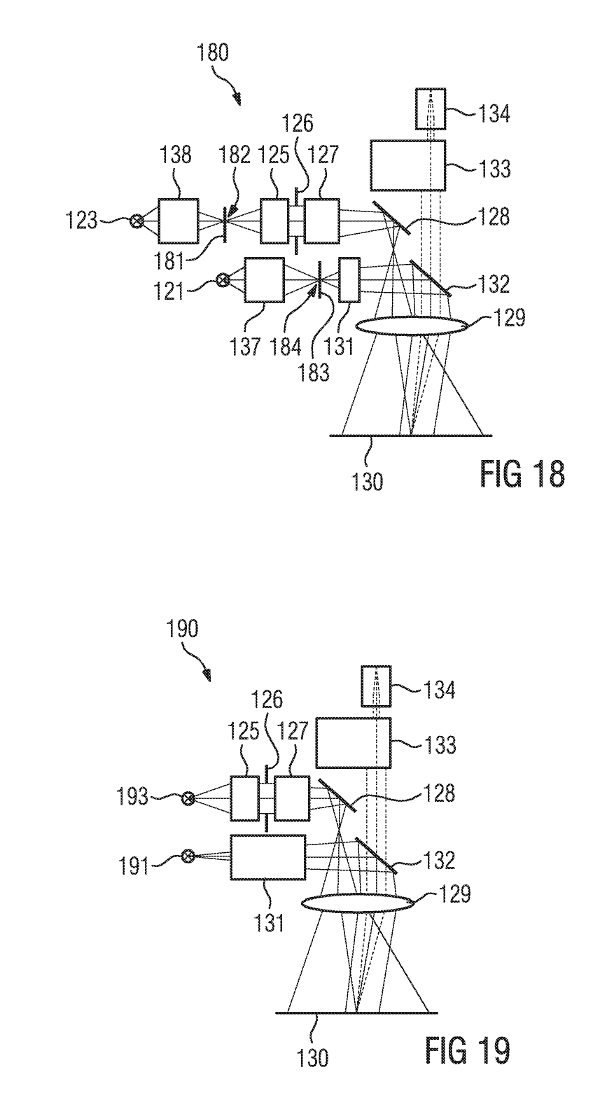

FIG. 18 shows a schematic illustration of a seventh example of a microscope with an apparatus for producing reflection-corrected images according to a further embodiment of the invention. The shown embodiment of a microscope 180 corresponds in substantial parts to the microscope 136 shown in FIG. 13, wherein the sub-aperture modulation device 141 from FIG. 13, which was used for a plurality of illumination beam paths, was replaced by a first sub-aperture modulation device 181, by means of which there is a realization of the sub-aperture modulation by time-varying shadowing at the ambient illumination pupil 182 in the plane that is conjugate to the ambient illumination source 123, or in the direct vicinity of said plane, and by a second sub-aperture modulation device 183, by means of which there is a realization of the sub-aperture modulation by time-varying shadowing at the coaxial illumination pupil 184 in the plane that is conjugate to the coaxial illumination source 121, or in the direct vicinity of said plane. At these locations, it is possible, for example, to use moving mechanical stops or actuatable LCD aperture stops for targeted disjoint illumination pupil shadowing for the individual illumination beam paths.

FIG. 19 shows a schematic illustration of an eighth example of a microscope with an apparatus for producing reflection-corrected images according to a further embodiment of the invention. The shown embodiment of a microscope 190 corresponds in substantial parts to the microscope 120 shown in FIG. 12. However, provision is not made here for any sub-aperture modulation device 135, as provided in FIG. 12, that is separate from the illumination sources 121, 123. Instead, the sub-aperture modulation device is identical to the respective coaxial illumination source 191 or ambient illumination source 193. To this end, an illuminated field array of an LED chip respectively serves in the shown embodiment as a coaxial illumination source 191 and as an ambient illumination source 193. The area of the illuminated field array that can be illuminated predefines the respective illumination pupil, and first and second sub-aperture regions for emitting or masking some of the illumination are defined by activating or deactivating portions of the illuminated field array, i.e. by a time-varying actuation and activation or deactivation of luminous area regions on the respective LED chip.

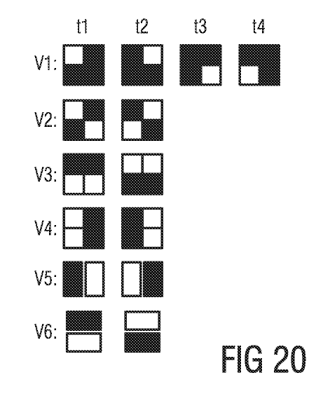

To this end, FIG. 20 shows a schematic illustration of examples for sub-aperture illumination options of an illuminated field array of an LED chip by time varying activation and deactivation of separated luminous area regions on the LED chip Luminous field regions illustrated in black represent deactivated regions which do not emit light; luminous field regions illustrated in white denote activated luminous area regions which emit light. In the shown example variants V1 to V6, the illuminated field array has 2×2=4 separately actuatable luminous area regions, with the illuminated field array being switched over at the four times t1, t2, t3, and t4 in the first example variant V1. In the second to sixth example variant V2 to V6, the illuminated field array is in each case switched over at the two times t1 and t2. Moreover, the example variant V2 illustrates the option of a disjoint decomposition, which pierces itself in reciprocal fashion.

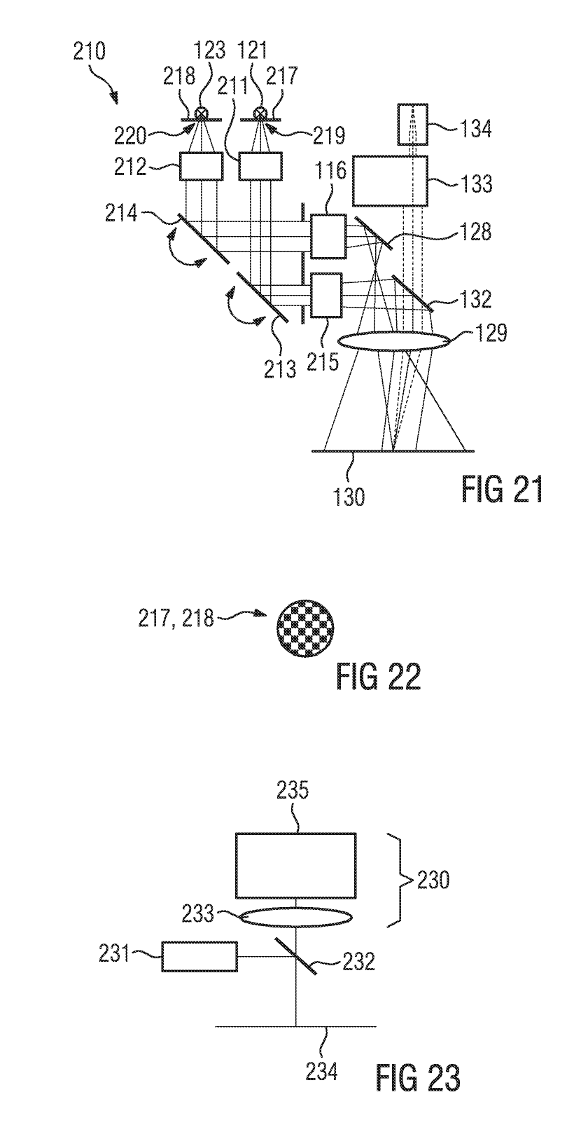

FIG. 21 shows a schematic illustration of a ninth example of a microscope with an apparatus for producing reflection-corrected images according to a further embodiment of the invention. In the shown embodiment of a microscope 210, the shown coaxial illumination device and the ambient illumination device are respectively designed in such a way that the illumination beam paths of the coaxial illumination source 121 and of the ambient illumination source 123 are collimated by an optical system 211 and an optical system 212 (e.g. Köhler illumination). Then, respectively in the collimated illumination beam path, the image of the respective illumination reflection (for example of the corneal reflection in the case of ophthalmic operating microscopes) is moved to various positions by controllable tiltable mirrors or DMDs. In FIG. 21, this is carried out by the mirror 213 that is rotatable through an angle for the coaxial illumination beam path and by the rotatable mirror 214 for the ambient illumination beam path. The coaxial illumination beam path then reaches the object plane 130 via a radiant field stop (LFB) and the optical system OS4 215, the reflection path of an optical splitter 132 and the main objective 129. The ambient illumination beam path reaches the object plane 130 via a radiant field stop (LFB) and the optical system OS2 216, the deflection mirror 128 and the main objective 129. The observation beam path (illustrated in a dashed fashion) runs from the object plane 130 through the main objective 129 and the traversing path of the optical splitter 132 into the magnification system 133 and the recording device 132 with the digital observation port(s).

The sub-aperture stops 217 and 218 are introduced into the coaxial illumination beam path and the ambient illumination beam path directly after the coaxial illumination source 121 and the ambient illumination source 123 at the locations of the respective illumination pupils 219, 220. To this end, FIG. 22 shows a schematic illustration of an example for a sub-aperture stop that is suitable for use in a microscope according to FIG. 21. Here, black regions have a shadowing effect while regions illustrated in white transmit light. Using this, it is possible to shadow a sub-aperture region of the illumination pupil of the respective illumination source while light reaches the respective optical system through the other sub-aperture region. The sub-aperture stops 217, 218 can be stationary stops. The modulation of the respective illumination beam path arises in the embodiment shown in FIG. 21 by virtue of tilting or rotating the mirrors 213, 214 or a stationary DMD micro-system. In this way, it is not necessary for the sub-aperture modulation for the movement to be carried out at the location of the illumination pupils 219, 220. Instead, the light of the respective illumination source is initially collimated and it can then be deflected in a targeted manner by the controllable tilt mirrors or DMDs in order to move the reflection image of the illuminated stop(s) in a targeted manner such that the reflections can be corrected or eliminated by calculation.

FIG. 23 shows a schematic illustration of an example for the arrangement of an illumination module 231 for a microscope 230. As shown above, the apparatus according to the invention for producing reflection-corrected images of an object can be embodied as a microscope or as a part thereof. In one embodiment, provision is made, in particular, for at least one illumination device for the illumination device to be integrated in an illumination module 231 together with an associated sub-aperture modulation device, said illumination module being able to emit sub-modulated light, said light then illuminates the object, for example via the reflection path of an optical splitter 232, which is introduced into the observation beam path of a microscope 230 below the main objective 233 of the microscope 230, i.e. between the main microscope 233 and object plane 234. Thus, the sub-aperture modulation device modifies or modulates the illumination beam path only in a region between the main objective 233 of the microscope 230 and the object or the object plane 234, for example by time-varying partial shadowing.

In particular, this offers the advantage of being able to provide a module to this end, said module, where necessary, also being able to be arranged, for example fitted, to the microscope retrospectively. By way of example, if the microscope 230 is an operating microscope which already comprises image recording sensors and one or more image output or reproduction devices, for example digital eyepieces, eyepieces with data superimposition, monitors or displays, and which comprises a processor for image processing purposes, which can be programmed to calculate a reflection-corrected image to be displayed from the sequence of sub-aperture-modulated images, it is possible in this embodiment, for example, to retrofit an available operating microscope for reflection correction purposes by providing the illumination module 231 and an optical splitter 232. Provision can likewise be made for the illumination module 231 to also already comprise the optical splitter 232. For reasons of clarity, the components of the microscope 230 apart from the main objective 233 are illustrated in a schematically combined manner as a common block 235 in FIG. 23.

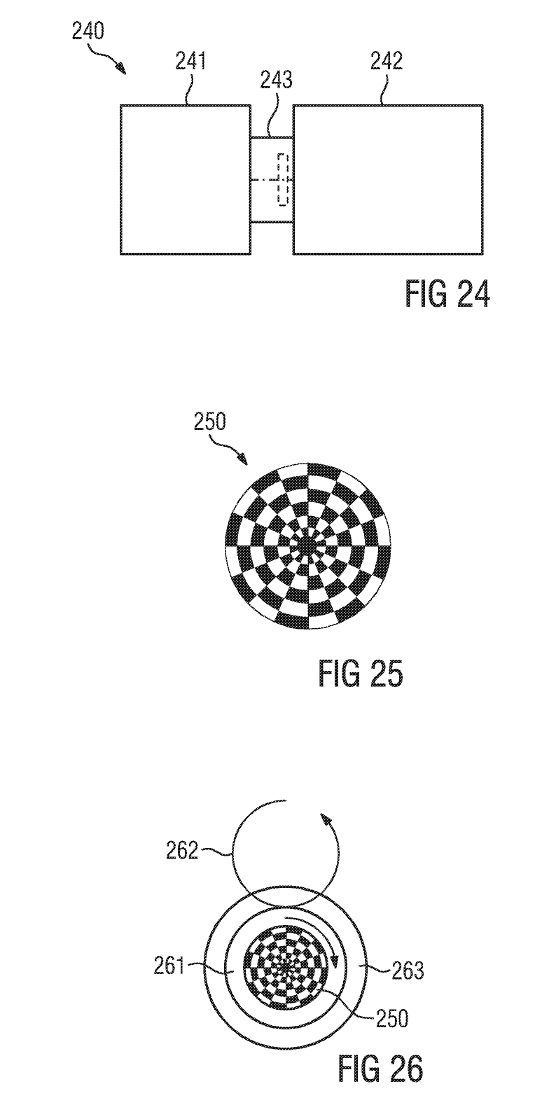

FIG. 24 shows a schematic illustration of a first example for an illumination device with a sub-aperture modulation device. Such a combination of illumination device and sub-aperture modulation device can be used, for example, as illumination module 231 according to FIG. 23, with the arrangement below a main objective of a microscope only constituting one example.

The shown illumination device 240 comprises a (primary or secondary) illumination source 241, optionally including additional optical devices, and an optical system 242 as an illumination optical unit. Here too, provision is made for the aperture, i.e. the area of the illumination pupil of the illumination source 241, to be decomposed in a temporal sequence into disjoint luminous and non-luminous sub-aperture regions. In the illumination device 240 shown in FIG. 24, the sub-aperture modulation device 243 is integrated into the illumination device, for example for an operating microscope. Thus, the sub-aperture modulation device can be integrated into the microscope without having to undertake structural modifications at the further optical systems of the microscope. Moreover, the location of the sub-aperture modulation can be relocated to a location of the microscope where, for example, the transfer of vibrations on the optical appliance is low, said vibrations otherwise being able to influence the observation result.

In one embodiment, the sub-aperture modulation device 243 comprises a sub-aperture mask or a sub-aperture stop made of light-transmissive and light-opaque regions, said sub-aperture modulation device, for the angle positions alpha and alpha+360°/n (alpha arbitrary), generating two disjoint transmissive decompositions of the mask region and thus respectively generating a first and a second sub-aperture region for each angular position. To this end, FIG. 25 shows a schematic illustration of an example for a suitable sub-aperture stop or sub-aperture mask 250, in which, as an example, a sub-aperture mask geometry for angle increments of 360°/16 with respectively 6 alternating transmissive and opaque regions along the radial direction is shown.

The geometric design of the regions on the sub-aperture mask can also be designed differently in respect of number, position, form, and size of the light-transmissive and light-opaque regions. By way of example, curved spokes are also possible instead of the straight spokes shown in FIG. 25, for example as a result of a radially increasing shear of the pattern.

By way of example, the sub-aperture mask 250 can be realized as a chromium mask on an optically transmissive substrate.

In an exemplary embodiment, the sub-aperture mask 250 is applied to a substrate, the light-transmissive regions of which on the front and/or rear side have an optically scattering effect in order to manipulate the angle distribution of the illumination. In a further exemplary embodiment, the sub-aperture mask 250 is applied to a substrate whose areas in the light-transmissive regions have an optically refractive effect in order to manipulate the image of the illumination pupil or illumination aperture and the angle distribution of the illumination.

The sub-aperture modulation device 243 provides for a rotatable bearing of the sub-aperture mask 250 about the axis of rotation thereof. FIG. 26 shows a schematic illustration of an example for a rotatably mounted receptacle 261 of a sub-aperture stop or sub-aperture mask 250, and a drive 262 for the receptacle 261. By way of example, the drive can be a drive with a friction wheel, a gearing or a belt. The sub-aperture mask 250 is introduced in a bore of the receptacle 261 and rotates with the latter when the latter is driven about the axis of rotation. The rotating receptacle 261 itself is held in the process by a secure holder or enclosure 263. In one embodiment, a position sensor (not shown) of the angle position of the rotatable sub-aperture mask 250 is provided.

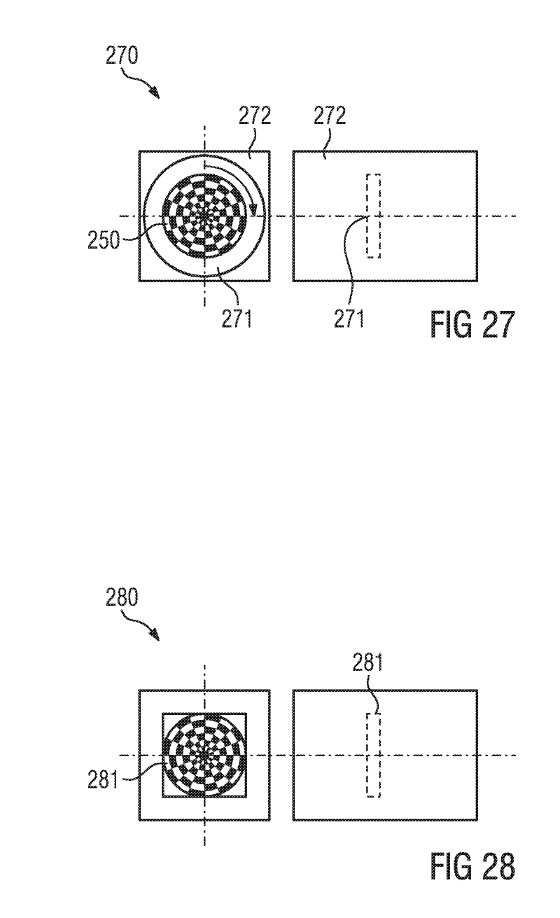

FIG. 27 shows, in a plan view and in a side view, a schematic illustration of an example for a sub-aperture stop or sub-aperture mask 250 that is integrated into the hollow shaft motor 270. The hollow shaft motor 270 serves as a drive for rotating the sub-aperture mask 250. In the shown embodiment, provision is made for the sub-aperture mask 250 to be received centered in relation to the axis of rotation in the rotor 271 of a hollow shaft motor 270 which is rotatably mounted in the stator 272 of the hollow shaft motor. The hollow shaft motor provides for light to be radiated in along the axis of rotation of the rotor onto the sub-aperture mask 250 that is rotatable with the latter and for sub-aperture-modulated light to be emitted in order to produce different illumination situations.

In other embodiments, the mechanically movable sub-aperture masks are moved in different ways. By way of example, provision can be made of realizing a linear back and forth movement of the mask in the case of a sub-aperture modulation device with a checkerboard-like sub-aperture mask or a linear mask.

As an alternative to the approach of using a mechanically moving sub-aperture mask for sub-aperture modulation purposes, provision is made in other embodiments of providing a sub-aperture modulation device, which may correspond to the sub-aperture modulation device 243 shown in FIG. 24, for example, having a stationary actuatable stop in order to realize time-varying light-guiding and non-light-guiding sub-aperture stop regions.

To this end, FIG. 28 is a schematic illustration of an example for a sub-aperture modulation device 280 with an electronically actuatable stop 281 (here in transmission), for example on the basis of an LCD, i.e. as an LCD sub-aperture stop. The stop is configured as a programmable stop, optionally in combination with optical polarization elements.

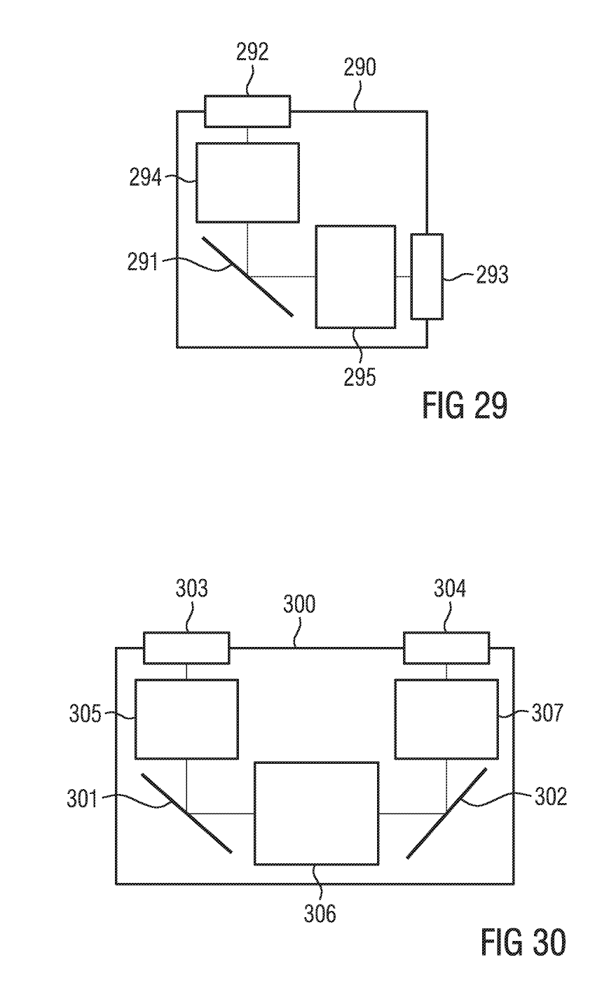

FIG. 29 shows a schematic illustration of a further example for a sub-aperture modulation device. The sub-aperture modulation device 290 provides for the use of a stationary actuatable stop on the basis of a micro-electromechanical system (MEMS) 291. By way of example, the MEMS can be a digital micromirror device (DMD) with micromirror actuators arranged in a matrix-shaped manner, the actuation of which is configured to steer only a sub-aperture component of the light, fed by an input 292 of the sub-aperture modulation device 290, to an output 293 of the sub-aperture modulation device 290 in order thus to realize time-varying light-guiding and non-light guiding stop regions. Here, the first optical system 294 and the second optical system 295 serve to image input 292, MEMS 291, and output 293 onto one another in a conjugate manner.

FIG. 30 shows a schematic illustration of another further example for a sub-aperture modulation device. The sub-aperture modulation device 300 provides for the use of a stationary actuatable stop on the basis of two micro-electromechanical systems (MEMS) 301, 302. The MEMS 301, 302 can be digital micromirror devices (DMD) with micromirror actuators arranged in a matrix-shaped manner, the actuation of which is configured to steer only a sub-aperture component of the light, fed by an input 303 of the sub-aperture modulation device 300, to an output 304 of the sub-aperture modulation device 300 in order thus to realize time-varying light-guiding and non-light guiding stop regions. Here, the first optical system 305, the second optical system 306, and the third optical system 307 serve to image input 303, the MEMS 301, 302, and output 304 onto one another in a conjugate manner.

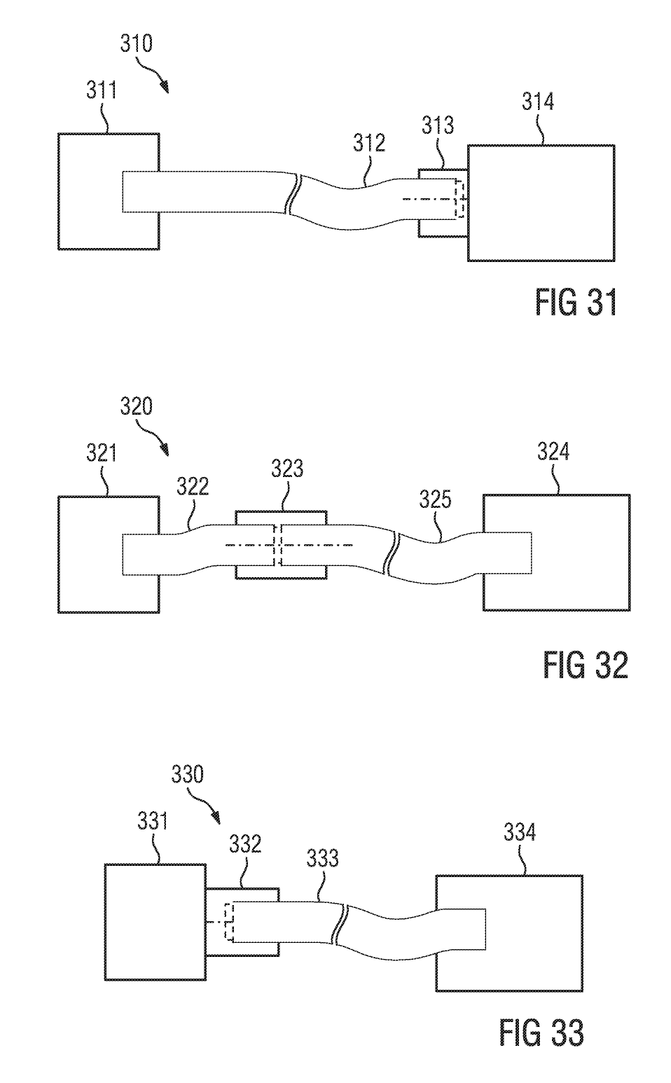

While both components are directly connected in the first example of an illumination device with a sub-aperture modulation device shown in FIG. 24, FIG. 31 shows a schematic illustration of a second example for an illumination device 310 with a sub-aperture modulation device, in which the illumination source 311 can be a primary illumination source comprising an input coupling optical unit, by means of which the emitted light is coupled into a light carrier bundle 312, the other end of which, as an illumination pupil of a secondary illumination source, then being positioned immediately in front of the sub-aperture mask of the sub-aperture modulation device 313 which carries out the sub-aperture modulation and feeds the modulated light into an optical system 314 as an illumination optical unit. In this way, the primary illumination source can be chosen independently of structural restrictions in a microscope, for example, and it can be arranged externally. Then, all that is decisive for positioning the secondary source is whether the position is reachable by the optical fiber bundle or the light carrier bundle 312. By way of example, this allows the sub-aperture modulation device to be integrated in an operating microscope while the primary illumination source is arranged externally. The light carrier bundle facilitates great flexibility in the structural implementation.

FIG. 32 shows a schematic illustration of a third example for an illumination device 320 with a sub-aperture modulation device. Here too, the illumination source 321 can be a primary illumination source comprising an input coupling optical unit, by means of which the emitted light is coupled into a light carrier bundle 322, the other end of which, as an illumination pupil of a secondary illumination source, then being positioned immediately in front of the sub-aperture mask of the sub-aperture modulation device 323, the latter carrying out the sub-aperture modulation and feeding the modulated light into an optical system 324 as an illumination optical unit. In this way, the primary illumination source can be chosen independently of structural restrictions in a microscope, for example, and it can be arranged externally. Unlike the second example shown in FIG. 31, it is also possible here to provide the sub-aperture modulation device 323 as an external component since the sub-aperture-modulated light is not fed directly into the optical system 324 but it is connected to the optical system 324, which may be the illumination optical unit on the operating microscope, via a second light carrier bundle 325. By arranging the sub-aperture modulation device outside of the microscope, the transfer of vibrations which could possibly be produced by a sub-aperture modulation device with mechanically moving components and which could possibly impair the observation result is avoided or at least greatly reduced.

In one embodiment, the second light carrier bundle 325 is designed as a coherent fiber bundle such that the sub-aperture decompositions by the second light carrier bundle 325 can be transferred with the greatest similarity to the location of the entry pupil of the optical system 324, i.e. the illumination optical unit in the operating microscope, for example.

In another embodiment, a non-coherent fiber bundle is used as the second light carrier bundle 325, and so the sub-aperture decomposition is locally redistributed.

FIG. 33 shows a schematic illustration of a fourth example for an illumination device 330 with a sub-aperture modulation device. The illumination source 331 can be an external primary illumination source, into which a sub-aperture modulation device 332 is integrated, the latter being connected to the optical system 334, e.g. the illumination optical unit of the optical appliance (e.g. operating microscope), via a light carrier bundle 333.

In one embodiment, the light carrier bundle 333 is designed as a coherent fiber bundle such that the sub-aperture decompositions by the light carrier bundle 333 can be transferred with the greatest similarity to the location of the entry pupil of the illumination optical unit in the operating microscope.

In another embodiment, a non-coherent fiber bundle is used as the light carrier bundle 333, as a result of which the sub-aperture decomposition is locally redistributed to a further extent.

Further embodiments of a microscope according to the invention with an apparatus for producing reflection-corrected images are shown below, in which the basic design corresponds to that of the embodiment shown in FIG. 12, wherein, however, the illumination devices and sub-aperture modulation devices differ. In order to avoid repetition, the description of the following exemplary embodiments is restricted to the features differing from those shown in FIG. 12, with the same reference signs referring to the same or similar components.

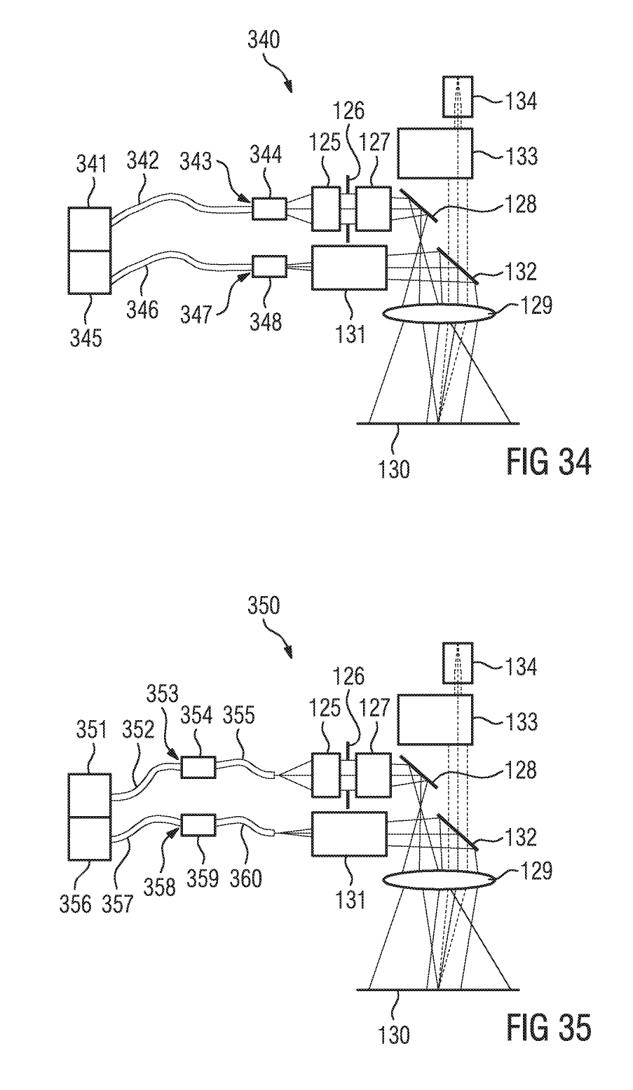

FIG. 34 shows a schematic illustration of a tenth example of a microscope, in particular an ophthalmic operating microscope, with an apparatus for producing reflection-corrected images according to a further embodiment of the invention. In the shown embodiment of a microscope 340, the ambient illumination device comprises an optical system 125, a radiant field stop 126 and a further optical system 127. The ambient illumination beam path is imaged into the object plane 130 through the illuminated radiant field stop 126, via a deflection mirror 128 and through the main objective 129 of the operating microscope 120.

The ambient illumination device moreover comprises a primary ambient illumination source 341, the light of which is coupled into a first light carrier bundle 342, the associated output of which acts as a secondary ambient illumination source 343 with an illumination pupil that, at the location of the secondary illumination source 343, is decomposed in a time varying manner into respectively first light-transmissive and second, shadowing sub-aperture regions by a first sub-aperture modulation device 344. The ambient illumination modulated thus is then fed into the first optical system 125.

The shown coaxial illumination device comprises the coaxial illumination source 121 with the coaxial illumination pupil 122 and an optical system 131. Its associated coaxial illumination beam path is input coupled in the shown exemplary embodiment by the reflection path of an optical splitter 132 and steered into the object plane 130.

The observation beam path (dashed lines), by means of which the image of the object is recorded, runs through the main objective 129, the transmission path of the optical splitter 132, and through (an optional/optional) coaxial magnification system/systems 133. To this end, a recording device 134 with digital observation port(s), one observation port per observation channel, is provided in FIG. 12.

The coaxial illumination device moreover comprises a primary coaxial illumination source 345, the light of which is coupled into a second light carrier bundle 346, the associated output of which acts as a secondary coaxial illumination source 347 with an illumination pupil that, at the location of the secondary coaxial illumination source 347, is decomposed in a time varying manner into respectively first light-transmissive and second, shadowing sub-aperture regions by a second sub-aperture modulation device 348. The coaxial illumination modulated thus is then fed into the optical system 131.

In the shown embodiment, the sub-aperture modulation devices 344, 348 can be coupled directly to the illumination optical unit of the microscope, for example structurally integrated into the microscope, while the primary illumination sources 341, 345 can be arranged externally.

FIG. 35 shows a schematic illustration of an eleventh example of a microscope with an apparatus for producing reflection-corrected images according to a further embodiment of the invention. In the microscope 350 shown here, too, the basic structure corresponds to the embodiment of a microscope shown in FIG. 12.

Unlike what is shown in FIG. 34, the ambient illumination device moreover comprises a primary ambient illumination source 351 in this case, the light of which is coupled into a primary first light carrier bundle 352, the associated output of which acts as a secondary ambient illumination source 353 with an illumination pupil that, at the location of the secondary ambient illumination source 353, is decomposed in a time varying manner into respectively first light-transmissive and second shadowing sub-aperture regions by a first sub-aperture modulation device 354. The ambient illumination modulated thus is then coupled into a secondary first light carrier bundle 355 and fed into the first optical system 125 at the output thereof.

Also unlike what is shown in FIG. 34, the coaxial illumination device moreover comprises a primary coaxial illumination source 356 in this case, the light of which is coupled into a primary second light carrier bundle 357, the associated output of which acts as a secondary coaxial illumination source 358 with an illumination pupil that, at the location of the secondary coaxial illumination source 358, is decomposed in a time varying manner into respectively first light-transmissive and second shadowing sub-aperture regions by a second sub-aperture modulation device 359. The coaxial illumination modulated thus is then coupled into a secondary second light carrier bundle 360 and fed into the optical system 131 at the output thereof.

In the shown embodiment, the sub-aperture modulation devices 354, 359, like the primary illumination sources 341, 345, can be arranged externally and can be connectable to the illumination optical unit of the microscope by way of optical waveguides and, where necessary, appropriate optical coupling interfaces.

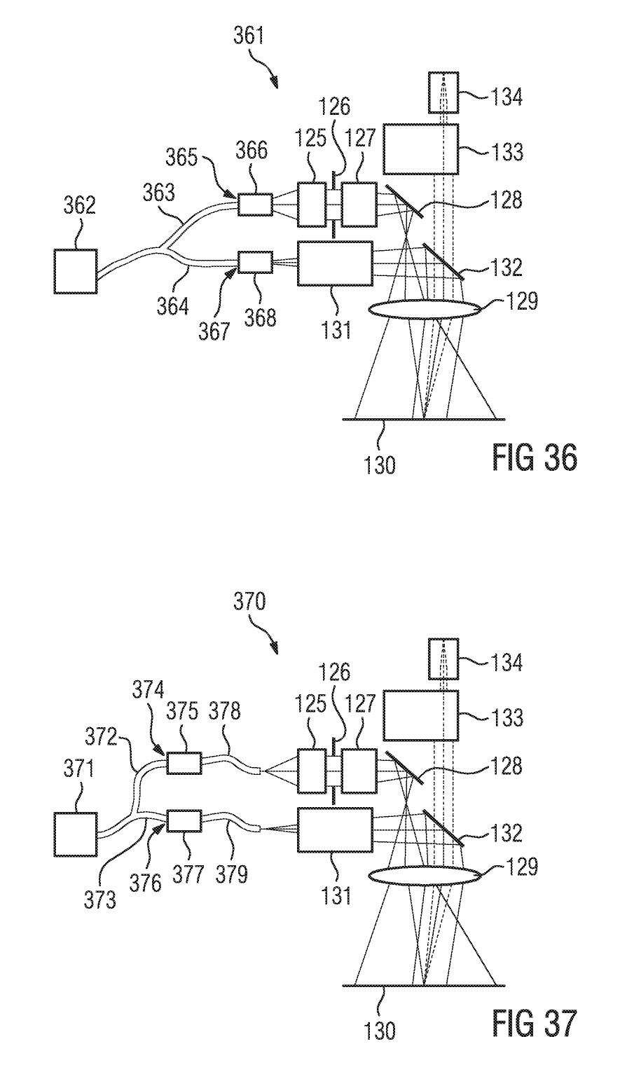

FIG. 36 shows a schematic illustration of a twelfth example of a microscope with an apparatus for producing reflection-corrected images according to a further embodiment of the invention. In the microscope 361 shown here, too, the basic structure corresponds to the embodiment of a microscope shown in FIG. 12.

Unlike what is shown in FIG. 34, the ambient illumination device and the coaxial illumination device are realized here with the same primary illumination source 362, the light of which is coupled into a divided light carrier bundle that consists of a first partial light carrier bundle 363 and a second partial light carrier bundle 364. The output belonging to the first partial light carrier bundle 363 acts as a secondary ambient illumination source 365 with an illumination pupil that, at the location of the secondary ambient illumination source 365, is decomposed in a time varying manner into respectively first light-transmissive and second shadowing sub-aperture regions by a first sub-aperture modulation device 366. The ambient illumination modulated thus is then fed into the first optical system 125.

The output belonging to the second partial light carrier bundle 364 acts as a secondary coaxial illumination source 367 with an illumination pupil that, at the location of the secondary coaxial illumination source 367, is decomposed in a time varying manner into respectively first light-transmissive and second shadowing sub-aperture regions by a second sub-aperture modulation device 368. The coaxial illumination modulated thus is then fed into the optical system 131.

In the shown embodiment, the sub-aperture modulation devices 366, 368 can be coupled directly to the illumination optical unit of the microscope, for example structurally integrated into the microscope, while a single primary illumination source, which may be arranged externally, is required on account of the use of a split light carrier bundle.

FIG. 37 shows a schematic illustration of a thirteenth example of a microscope with an apparatus for producing reflection-corrected images according to a further embodiment of the invention. In the microscope 370 shown here, too, the basic structure corresponds to the embodiment of a microscope shown in FIG. 12.

As shown in FIG. 36, the ambient illumination device and the coaxial illumination device are realized here, too, with a common primary illumination source 371, the light of which, in this case, is coupled into a divided light carrier bundle that consists of a primary first partial light carrier bundle 372 and a primary second partial light carrier bundle 373. The output belonging to the primary first partial light carrier bundle 372 acts as a secondary ambient illumination source 374 with an illumination pupil that, at the location of the secondary ambient illumination source 374, is decomposed in a time varying manner into respectively first light-transmissive and second shadowing sub-aperture regions by a first sub-aperture modulation device 375. The ambient illumination modulated thus is then coupled into a secondary first light carrier bundle 378 and fed into the first optical system 125 at the output thereof.

The output belonging to the primary second partial light carrier bundle 373 acts as a secondary coaxial illumination source 376 with an illumination pupil that, at the location of the secondary coaxial illumination source 376, is decomposed in a time varying manner into respectively first light-transmissive and second shadowing sub-aperture regions by a second sub-aperture modulation device 377. The coaxial illumination modulated thus is then coupled into a secondary second light carrier bundle 379 and fed into the optical system 125 at the output thereof.

In the shown embodiment, the sub-aperture modulation devices 375, 377 and the common primary illumination source 371 can be arranged externally and can be connectable to the illumination optical unit of the microscope by way of optical waveguides and, where necessary, an appropriate optical coupling interface.

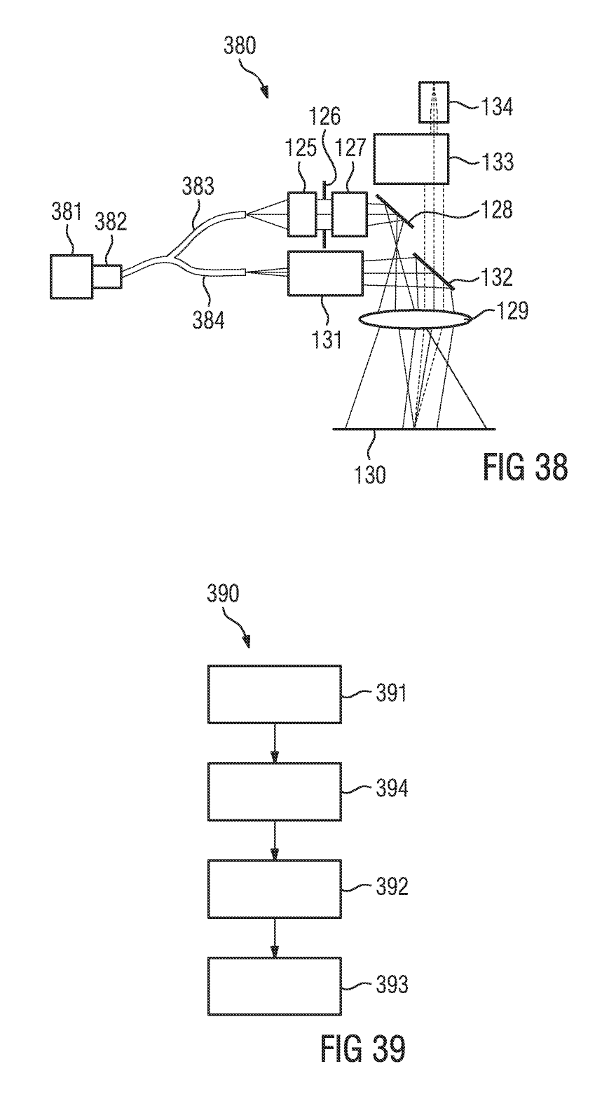

FIG. 38 shows a schematic illustration of a fourteenth example of a microscope with an apparatus for producing reflection-corrected images according to a further embodiment of the invention. In the microscope 380 shown here, too, the basic structure corresponds to the embodiment of a microscope shown in FIG. 12.

As shown in FIG. 36, the ambient illumination device and the coaxial illumination device are, here too, realized with a common illumination source 381 with an illumination pupil that is directly decomposed in a time varying manner into respective first light-transmissive and second, shadowing sub-aperture regions by a single common sub-aperture modulation device 382. The illumination modulated thus is then coupled into a split light carrier bundle that consists of the first partial light carrier bundle 383 and a second partial light carrier bundle, and said illumination modulated thus is fed into the first optical system 125 at the output of the first partial light carrier bundle 383 and fed into the optical system 131 at the output of the second partial light carrier bundle 384.

In the shown embodiment, a common sub-aperture modulation device 382 can be integrated into a common illumination source 381, can be arranged externally and can be connectable to the illumination optical unit of the microscope by way of a split light carrier bundle and, where necessary, appropriate optical coupling interfaces.

FIG. 39 shows a schematic illustration of an example for a reflection correction method for correcting digital microscopic images according to a further embodiment of the invention. Initially, an object and an apparatus for producing reflection-corrected images are provided in a provision step (not illustrated). The reflection correction method 390 for correcting digital microscopic images then comprises at least illuminating 391 an object through an illumination pupil of an illumination device, recording 392 a sequence of images of the object that belong to illumination situations, which differ from one another in each case, by way of an image recording sensor device, and producing 393 a reflection-corrected image from the sequence using an image processing device. In particular, the reflection correction method according to the invention also comprises producing 394 the illumination situations, which differ from one another, using an illumination modulation device in such a way that, for each image region in an image from the sequence containing a reflected illumination image of at least part of the illumination pupil, in particular an illumination image whose image position is situated at or in the vicinity of that of the object, there is a corresponding image region without this reflected illumination image in at least one of the remaining images from the sequence, wherein producing the illumination situations, which differ from one another, comprises producing the illumination situations, which differ from one another, by a sequential modification of an illumination beam path from the illumination pupil to the object, wherein, in each case, light from a respectively associated first sub-aperture region of the illumination pupil is incident on the object, while no light is incident on the object from a respective second sub-aperture region of the illumination pupil.

To the extent that nothing else is specified, terms such as “first” and “second” or the like (for example, first and second optical system, first and second sub-aperture modulation device, etc.) were used to distinguish between the respective elements. Therefore, the use of the terms does not necessarily imply a functional or any other prioritization of one or the other element.

The present invention has been described in detail on the basis of exemplary embodiments for explanation purposes. A person skilled in the art recognizes that details that were described with reference to one embodiment can also be used in other embodiments. Therefore, the invention is not intended to be restricted to individual embodiments, but rather only by the appended claims.

### LIST OF REFERENCE SIGNS

10 Apparatus for producing reflection-corrected images
11 Object
12 Illumination device
13 Illumination source
14 Illumination pupil
15 Image recording sensor device
16 Image processing device
17 Sub-aperture modulation device
18 Illumination beam path
19 Image display device
21 First sub-aperture region
22 Second sub-aperture region
101 Illumination pupil
102 First sub-aperture regions
103 Second sub-aperture regions
111 Illumination pupil
112 First sub-aperture regions
113 Second sub-aperture regions
120 Microscope
121 Coaxial illumination source
122 Coaxial illumination pupil
123 Ambient illumination source
124 Ambient illumination pupil
125 Optical system
126 Radiant field stop
127 Further optical system
128 Deflection mirror
129 Main objective
130 Object plane
131 Optical system
132 Optical splitter
133 Magnification system
134 Digital observation port
135 Sub-aperture modulation device
136 Microscope
137 Optical system
138 Optical system
139 Illumination pupil
140 Illumination pupil
141 Sub-aperture modulation device
142 Microscope
143 Illumination pupil
144 Illumination pupil
145 Sub-aperture modulation device
150 Microscope
151 Sub-aperture modulation device
152 Illumination pupil
153 Sub-aperture modulation device
154 Optical system
160 Microscope
161 Sub-aperture modulation device
162 Illumination pupil
163 Deflection mirror
164 Sub-aperture modulation device
165 Illumination pupil
170 Microscope
171 First DMD micro-system
172 Second DMD micro-system
180 Microscope
181 First sub-aperture modulation device
182 Ambient illumination pupil
183 Second sub-aperture modulation device
184 Coaxial illumination pupil
190 Microscope
191 Coaxial illumination source
193 Ambient illumination source
210 Microscope
211 Optical system
212 Optical system
213 Rotatable mirror
214 Rotatable mirror
215 Optical system
216 Optical system
217 Sub-aperture stop
218 Sub-aperture stop
219 Illumination pupil
220 Illumination pupil
230 Microscope
231 Illumination module
232 Optical splitter
233 Main objective
234 Object plane
235 Block
240 Illumination device
241 Illumination source
242 Optical system
243 Sub-aperture modulation device
250 Sub-aperture mask
261 Receptacle
262 Drive
263 Enclosure
270 Hollow shaft motor
271 Rotor
272 Stator
280 Sub-aperture modulation device
281 Electronically actuatable stop
290 Sub-aperture modulation device
291 Micro-electromechanical system
292 Input
293 Output
294 First optical system
295 Second optical system
300 Sub-aperture modulation device
301 Micro-electromechanical system
302 Micro-electromechanical system
303 Input
304 Output
305 First optical system
306 Second optical system
307 Third optical system
310 Illumination device
311 Illumination source
312 Light carrier bundle
313 Sub-aperture modulation device
314 Optical system
320 Illumination device
321 Illumination source
322 Light carrier bundle
323 Sub-aperture modulation device
324 Optical system
325 Second light carrier bundle
330 Illumination device
331 Illumination source
332 Sub-aperture modulation device
333 Light carrier bundle
334 Optical system
340 Microscope
341 Primary ambient illumination source
342 First light carrier bundle
343 Secondary ambient illumination source
344 First sub-aperture modulation device
345 Primary coaxial illumination source
346 Second light carrier bundle
347 Secondary coaxial illumination source
348 Second sub-aperture modulation device
350 Microscope
351 Primary ambient illumination source
352 Primary first light carrier bundle
353 Secondary ambient illumination source
354 First sub-aperture modulation device
355 Secondary first light carrier bundle
356 Primary coaxial illumination source
357 Primary second light carrier bundle
358 Secondary coaxial illumination source
359 Second sub-aperture modulation device
360 Secondary second light carrier bundle
361 Microscope
362 Primary illumination source
363 First partial light carrier bundle
364 Second partial light carrier bundle
365 Secondary ambient illumination source
366 First sub-aperture modulation device
367 Secondary coaxial illumination source
368 Second sub-aperture modulation device
370 Microscope
371 Primary illumination source
372 Primary first partial light carrier bundle
373 Primary second partial light carrier bundle
374 Secondary ambient illumination source
375 First sub-aperture modulation device
376 Secondary coaxial illumination source
377 Second sub-aperture modulation device
378 Secondary first light carrier bundle
379 Secondary second light carrier bundle
380 Microscope
381 Illumination source
382 Sub-aperture modulation device
383 First partial light carrier bundle
384 Second partial light carrier bundle
390 Reflection correction method
391 Illuminating an object
392 Recording a sequence
393 Producing a reflection-corrected image
394 Producing the illumination situations, which differ from one another

1. An apparatus for producing reflection-corrected images, preferably reflection-corrected microscopic images, of an object, comprising
an illumination device with an illumination source and an illumination pupil for illuminating an object;
an image recording sensor device that is configured to record a sequence of images of the object that belong to illumination situations, which differ from one another in each case;
an image processing device that is configured to produce a reflection-corrected image from the sequence; and
a sub-aperture modulation device that is configured to produce the illumination situations, which differ from one another, in such a way that, for each image region in an image from the sequence containing a reflected illumination image of at least part of the illumination pupil, there is a corresponding image region without this reflected illumination image in at least one of the remaining images from the sequence; wherein
the sub-aperture modulation device comprises means for producing the illumination situations, which differ from one another, by a sequential modification of an illumination beam path from the illumination pupil to the object, wherein, in each case, light from a respectively associated first sub-aperture region of the illumination pupil is incident on the object while no light is incident on the object from a respective second sub-aperture region of the illumination pupil.

2. The apparatus as claimed in claim 1, wherein the means for producing the illumination situations, which differ from one another, comprise means for respectively modifying the illumination beam path in such a way that, when considered over all the illumination situations, which differ from one another, the respectively associated first sub-aperture regions are disjoint from one another.

3. The apparatus as claimed in claim 1, wherein the means for producing the illumination situations, which differ from one another, comprise means for respectively modifying the illumination beam path in such a way that, when considered over all the different illumination situations, a composition of the respective second sub-aperture regions covers the entire illumination pupil.

4. The apparatus as claimed in claim 1, wherein the illumination pupil is a first illumination pupil at the illumination source and the sub-aperture modulation device is configured to modify the illumination beam path from the first illumination pupil.

5. The apparatus as claimed in claim 1, wherein the illumination pupil is a second illumination pupil in a plane that is conjugate to the illumination source and the sub-aperture modulation device is configured to modify the illumination beam path from the second illumination pupil.

6. The apparatus as claimed in claim 1, wherein the means for producing the illumination situations, which differ from one another, comprise means for intermittently shadowing the respective second sub-aperture region.

7. The apparatus as claimed in claim 6, wherein the means for intermittently shadowing the respective second sub-aperture region comprise a movable mechanical sub-aperture mask.

8. The apparatus as claimed in claim 6, wherein the means for intermittently shadowing the respective second sub-aperture region comprise an electronically actuatable aperture stop.

9. The apparatus as claimed in claim 1, wherein the means for producing the illumination situations, which differ from one another, comprise means for intermittently coupling the respective first sub-aperture region into the illumination beam path without simultaneously coupling-in the respective second sub-aperture region.

10. The apparatus as claimed in claim 9, wherein the means for intermittently coupling the respective first sub-aperture region into the illumination beam path are configured to displace a position of the reflected illumination image of the respective first sub-aperture region in a targeted manner by a time-varying angle deflection.

11. The apparatus as claimed in claim 1, wherein the means for producing the different illumination situations comprise means for intermittently activating separately actuatable sub-aperture regions of the illumination source.

12. The apparatus as claimed in claim 11, wherein the illumination device as an illumination source comprises a secondary illumination source, into which light that was modulated by the sub-aperture modulation device is fed, said light being emitted by a primary illumination source.

13. The apparatus as claimed in claim 12, wherein the illumination device comprises at least one optical waveguide bundle and the secondary illumination source is an output of the optical waveguide bundle.

14. The apparatus as claimed in claim 1, wherein the apparatus comprises a further illumination device with a further illumination pupil for illuminating the object.

15. The apparatus as claimed in claim 14, wherein the sub-aperture modulation device is further configured to produce the illumination situations, which differ from one another, in such a way that, for each further image region in the image from the sequence containing a further reflected illumination image of at least a part of the further illumination pupil, too, a further corresponding image region without this further reflected illumination image is present in at least one of the remaining images from the sequence; and wherein the sub-aperture modulation device comprises means for producing the illumination situations, which differ from one another, by a sequential modification of a further illumination beam path from the further illumination pupil to the object, too, wherein, in each case, light from a respectively associated first sub-aperture region of the further illumination pupil is also incident on the object while no light is incident on the object from a respective second sub-aperture region of the further illumination pupil.

16. A microscope preferably an operating microscope, comprising an apparatus as claimed in claim 1.

17. The microscope as claimed in claim 16, wherein the illumination beam path from the illumination source comprises a beam path of a coaxial illumination.

18. The microscope as claimed in claim 16, wherein the apparatus comprises means to only steer the modified illumination beam path onto the object in a region between an objective of the microscope and the object.

19. The microscope as claimed in claim 16, having a display device which comprises at least a digital eyepiece, an eyepiece with data superimposition, a monitor or smartglasses.

20. A reflection correction method for correcting digital microscopic images, comprising the following steps:
illuminating an object through an illumination pupil of an illumination device;
recording a sequence of images of the object that belong to illumination situations, which differ from one another in each case, by way of an image recording sensor device;
producing a reflection-corrected image from the sequence using an image processing device; and
producing the illumination situations, which differ from one another, using an illumination modulation device in such a way that, for each image region in an image from the sequence containing a reflected illumination image of at least part of the illumination pupil, there is a corresponding image region without this reflected illumination image in at least one of the remaining images from the sequence; wherein
producing the illumination situations, which differ from one another, comprises producing the illumination situations, which differ from one another, by a sequential modification of an illumination beam path from the illumination pupil to the object, wherein, in each case, light from a respectively associated first sub-aperture region of the illumination pupil is incident on the object, while no light is incident on the object from a respective second sub-aperture region of the illumination pupil.

21. The reflection correction method as claimed in claim 20, wherein producing the reflection-corrected image from the sequence comprises, in a segmentation step, carrying out a deep-learning-based reflection segmentation for each image from the sequence and eliminating image regions that are detected as afflicted by reflections from the respective image and, in a combination-by-calculation step, carrying out a combination based on an HDR method by calculation of the images of the sequence resulting from the segmentation step for reflection-corrected imaging.
